(19) United States
(12) Patent Application Publication
(10) Pub. No.: US 2017/0083320 A1
(43) Pub. Date: Mar. 23, 2017

(54) PREDICATED READ INSTRUCTIONS

(71) Applicant: Microsoft Technology Licensing, LLC, Redmond, WA (US)

(72) Inventors: Douglas C. Burger, Bellevue, WA (US); Aaron L. Smith, Seattle, WA (US)

(73) Assignee: Microsoft Technology Licensing, LLC, Redmond, WA (US)

(21) Appl. No.: 15/004,761

(22) Filed: Jan. 22, 2016

Related U.S. Application Data
(60) Provisional application No. 62/221,003, filed on Sep. 19, 2015.

(51) Int. Cl. G06F 9/30

(52) U.S. Cl. CPC G06F 9/3016; G06F 9/30007; G06F 9/3004; G06F 9/30101

(57) ABSTRACT

Apparatus and methods are disclosed for example computer processors that are based on a hybrid dataflow execution model. Embodiments of the disclosed technology use read instructions to retrieve a value from a specified register in the register file of the processor architecture and send the value for use by one or more targets (e.g., other instructions in the instruction block). The read instruction may be predicated such that the instruction is only executed when a predicate condition is satisfied. In some examples of the disclosed technology, a compiler for such processors performs an analysis of the source and/or object code being compiled in order to determine whether operation(s) along conditional paths can be executed before or concurrently with determination of a condition on which the conditional operation(s) depend, thus improving processor efficiency.

### CROSS-REFERENCE TO RELATED APPLICATIONS

This application claims the benefit of U.S. Provisional Patent Application No. 62/221,003, entitled “BLOCK-BASED PROCESSORS,” filed Sep. 19, 2015, which application is incorporated herein by reference in its entirety.

### FIELD

This application relates to processors for performing computations. In particular, this application relates to block-based processor architectures (BB-ISAs), including explicit data graph execution (EDGE) architectures.

### BACKGROUND

Microprocessors have benefited from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for configuring, operating, and compiling code for, block-based processor architectures (BB-ISAs), including explicit data graph execution (EDGE) architectures. The described techniques and tools for solutions for, e.g., improving processor performance and/or reducing energy consumption can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, PDAs, touch screen tablet devices, tablet computers, wearable computers, and laptop computers.

Apparatus, methods, and computer-readable storage media are disclosed for compiling source and/or object code into block-based processor executable instructions. In certain examples of the disclosed technology, instruction blocks include an instruction block header and a plurality of instructions generating using the disclosed techniques. Furthermore, on account of the hybrid dataflow execution model, embodiments of the disclosed technology use read instructions to retrieve a value from a specified register in the register file of the processor architecture and send the value for use by one or more targets (e.g., other instructions in the instruction block). The read instruction may be predicated such that the instruction is only executed when a predicate condition is satisfied. In some examples of the disclosed technology, the compiler also performs an analysis of the source and/or object code being compiled in order to determine whether operations along conditional paths can be speculatively executed, thus improving processor efficiency and the overall speed with which an instruction block is executed.

In one example embodiment, the control unit of a processor core decodes a read instruction from the current instructions block, and the read instruction includes data indicating (a) an opcode for the read instruction; (b) a register identification for a target register from which a register value is to be read; and (c) one or more targets to which the register value is to be sent. The control unit then buffers the register value in one or more memory buffers associated with the one or more targets. In a related example, a read instruction is retrieved from a memory store storing a block of instructions, and the read instruction specifies (a) a register identification for a target register from which a register value is to be read; and (b) one or more targets to which the register value is to be sent. The register value is copied from the target register to one or more memory buffers associated with the one or more targets.

In an example compilation method, a data flow representation of the desired program is generated from the source code or object code, two or more conditional paths in the data flow representation are identified that are conditional on different outcomes of a condition, and block-based processor executable instructions for the program are generated, where the block-based processor executable instructions include at least one predicated read instruction for one of the conditional paths.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor core, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and instruction blocks, as can be used in some examples of the disclosed technology.

FIG. 5 illustrates block-based processor headers and instructions, as can be used in some examples of the disclosed technology.

FIG. 6 illustrates examples of source and assembler code, as can be used in some examples of the disclosed technology.

FIG. 7 illustrates a number of instructions blocks and processor cores, as can be used in some examples of the disclosed technology.

FIG. 8 is a flowchart illustrating an example method of executing instructions for an instruction block, as can be performed in certain examples of the disclosed technology.

FIG. 9 is a flowchart outlining an example of transforming code into block-based processor executable code, as can be performed in certain examples of the disclosed technology.

FIG. 10 illustrates two example instruction blocks for read instruction.

FIG. 11 illustrates example source code with two conditional paths.

FIG. 12 illustrates an example data flow graph for the source code of FIG. 11

FIG. 13 illustrates an example instruction block as can be generated by embodiments of the disclosed technology for executing the source code of FIG. 11.

FIG. 14 is a block diagram illustrating a compilation flow as can be used in examples of the disclosed technology.

FIG. 15 illustrates another example data flow graph for the source code of FIG. 11 in which operations from one of the conditional paths are speculatively performed.

FIG. 16 illustrates an example instruction block for the source code of FIG. 11 after hoisting of instruction to be speculatively computer is performed in accordance with embodiments of the disclosed technology.

FIG. 17 is a flow chart showing an example method for operating a processor in accordance with the disclosed technology.

FIG. 18 is a flow chart showing another example method for operating a processor in accordance with the disclosed technology.

FIG. 19 is a flow chart showing an example compilation method for generating block-based processor executable instructions from, for example, source code or object code for a program.

FIG. 20 illustrates a generalized example of a suitable computing environment in which described embodiments, techniques, and technologies, including configuring a block-based processor, can be implemented.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory devices (such as DRAM or SRAM), or nonvolatile memory or storage devices (such as hard drives, Flash memory, or NVRAM)) and executed on a computer (e.g., computing devices, including servers, desktops, laptops, smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor uses an EDGE ISA designed for area- and energy-efficient, high-ILP execution. In some examples, use of EDGE architectures and associated compilers finesses away much of the register renaming, CAMs, and complexity.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

Apparatus, methods, and computer-readable storage media are disclosed for compiling source and/or object code into block-based processor executable instructions. In certain examples of the disclosed technology, instruction blocks include an instruction block header and a plurality of instructions generating using the disclosed techniques. Furthermore, on account of the hybrid dataflow execution model, embodiments of the disclosed technology use read instructions to retrieve a value from a specified register in the register file of the processor architecture and send the value for use by one or more targets (e.g., other instructions in the instruction block). The read instruction may be predicated such that the instruction is only executed when a predicate condition is satisfied. In some examples of the disclosed technology, the compiler also performs an analysis of the source and/or object code being compiled in order to determine whether operations along condition paths can be re-arranged such that they are executed earlier (e.g., before or during determination of the condition on which they depend), thus improving processor efficiency and the overall speed with which an instruction block is executed.

As will be readily understood to one of ordinary skill in the relevant art, a spectrum of implementations of the disclosed technology is possible with various area and performance tradeoffs.

### III. Example Block-Based Processor

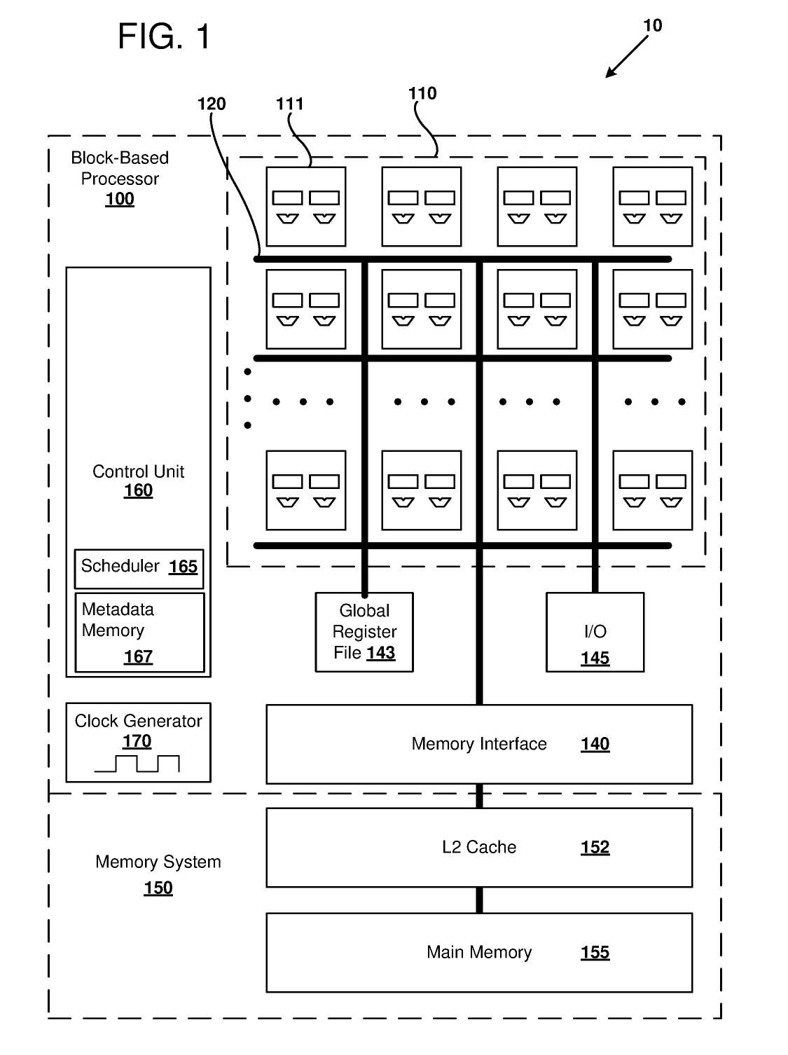

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. An external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface manages allocation of virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can generate and control the processor according to control flow and metadata information representing exit points and control flow probabilities for instruction blocks.

The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler 165 that is used to allocate instruction blocks to the processor cores 110. As used herein, scheduler allocation refers to directing operation of instruction blocks, including initiating instruction block mapping, fetching, decoding, executing, committing, aborting, idling, and refreshing an instruction block. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added. The scheduler 165 schedules the flow of instructions including allocation and de-allocation of cores for performing instruction processing, control of input data and output data between any of the cores, register files, the memory interface 140, and/or the I/O interface 145. The control unit 160 also includes metadata memory 167, which can be used to store data indicating execution flags for an instruction block.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

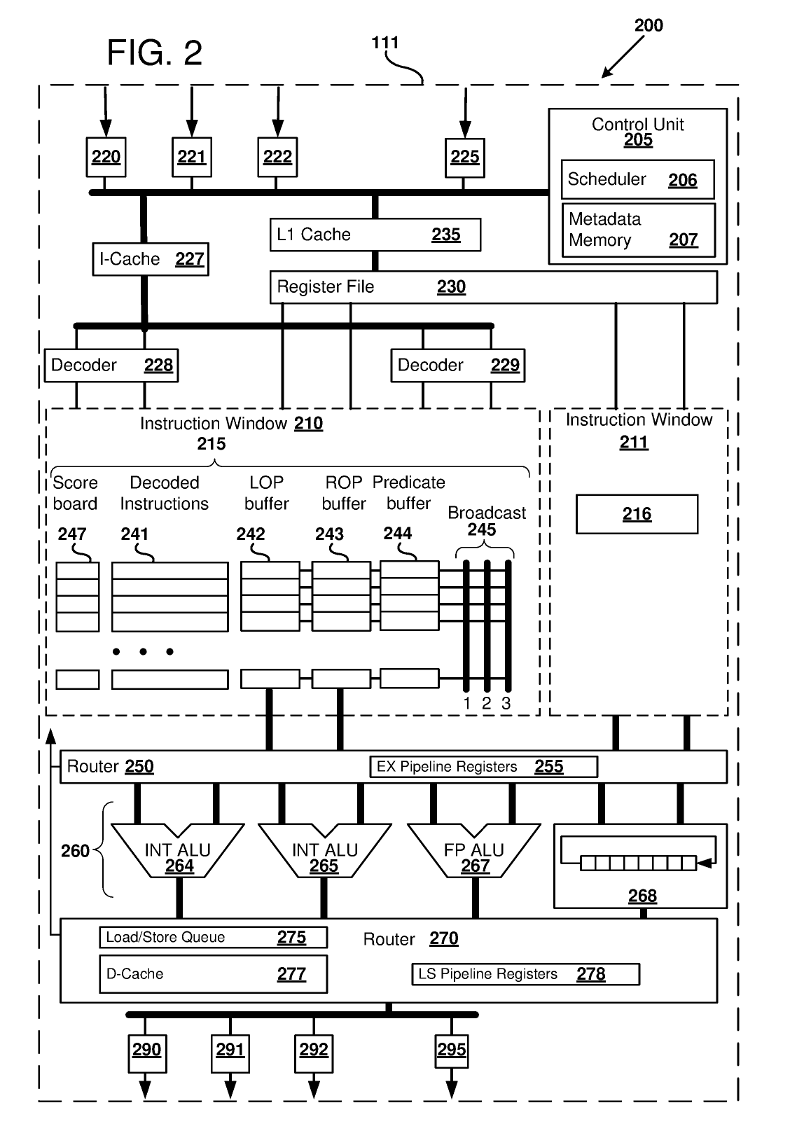

FIG. 2 is a block diagram further detailing an example microarchitecture for the block-based processor 100, and in particular, an instance of one of the block-based processor cores, as can be used in certain examples of the disclosed technology. For ease of explanation, the exemplary block-based processor core is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core 111 includes a control unit 205, which generates control signals to regulate core operation and schedules the flow of instructions within the core using an instruction scheduler 206. Operations that can be performed by the control unit 205 and/or instruction scheduler 206 can include generating and using block branch metadata representing control flow and exit points, allocation and de-allocation of cores for performing instruction processing, control of input data and output data between any of the cores, register files, the memory interface 140, and/or the I/O interface 145.

The control unit 205 can also include branch prediction circuitry that generates predictions of which instruction block(s) will be executed next. The branch prediction circuitry predicts which of a plurality of exit points of a block will be taken, and sends a signal that the control unit 205 uses to fetch, decode, and execute the next instruction block predicted. Any suitable branch prediction technique can be used. In some examples, a compiler or interpreter that generates the block-based processor instructions can include metadata in the block header or other location with hints for the branch prediction. In some examples, branch prediction is performed dynamically. For example, if an exit point is taken once, twice, or another number of times, then that exit point is designated as the predicted action for the next execution instance of the instruction block. In some examples, a table of instruction blocks and corresponding most likely exit points is maintained (e.g., in a user-visible, or non-user visible memory accessible to the control unit 205). In some examples, the predicted next instruction block is fetched, or fetched and decoded, but not executed until the previous block has committed. In some examples, block operands (e.g., from memory and/or registers) can be pre-fetched in addition to the next block instructions and block header. In some examples, the predicted next instruction block is also executed, even before the previous block has committed. In the event that the prediction is not correct (e.g., because the branch prediction was incorrect, or an exception occurs) the control unit 205 flushes the processor core speculatively executing the next predicted block, so that the processor state appears as if the incorrect branch was not taken.

In some examples, the instruction scheduler 206 is implemented using a general-purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general-purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

The control unit 205 further includes memory (e.g., in an SRAM or register) for storing control flow information and metadata. For example, control flow and metadata can be stored in metadata memory 207 that is accessible by the control unit 205 but that is not architecturally visible.

The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205 and/or instruction scheduler 206 are implemented at least in part using one or more of: hardwired finite state machines, programmable microcode, programmable gate arrays, or other suitable control circuits.

The exemplary processor core 111 includes two instructions windows 210 and 211, each of which can be configured to execute an instruction block. In some examples of the disclosed technology, an instruction block is an atomic collection of block-based-processor instructions that includes an instruction block header and a plurality of one or more instructions. As will be discussed further below, the instruction block header includes information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early fetching of instructions and/or data, improved branch prediction, speculative execution, improved energy efficiency, and improved code compactness. In other examples, different numbers of instructions windows are possible, such as one, four, eight, or other number of instruction windows.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instruction headers and/or instructions for an instruction block and stores the decoded instructions within a memory store 215 and 216 located in each respective instruction window 210 and 211. Further, each of the decoders 228 and 229 can send data to the control unit 205, for example, to configure operation of the processor core 111 according to execution flags specified in an instruction block header or in an instruction.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (For convenient explanation, this application will refer to 32-bits of data as a word, unless otherwise specified. Suitable processors according to the disclosed technology could operate with 8-, 16-, 64-, 128-, 256-bit, or another number of bits words) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, execution flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file 143 that is shared by a plurality of the processor cores. In some examples, individual register files associated with a processor core (e.g., instances of register file 230) can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, a predicate buffer 244, three broadcast channels 245, and an instruction scoreboard 247. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands and predicates are read from the operand buffers 242 and 243, and predicate buffer 244, respectively, not the register file. The instruction scoreboard 247 can include a buffer for predicates directed to an instruction, including wire-OR logic for combining predicates sent to an instruction by multiple instructions.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). The control unit can fetch and decode two instructions per clock cycle into each of the instruction windows 210 and 211. The control unit 205 provides instruction window dataflow scheduling logic to monitor the ready state of each decoded instruction's inputs (e.g., each respective instruction's predicate(s) and operand(s)) using the scoreboard 247. When all of the input operands and predicates for a particular decoded instruction are ready, the instruction is ready to issue. The control unit 205 then initiates execution of (issues) one or more next instruction(s) (e.g., the lowest numbered ready instruction) each cycle, and control signals based on the decoded instruction and the instruction's input operands are sent to one or more of functional units 260 for execution. The decoded instruction can also encode a number of ready events. The scheduler in the control unit 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 247 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and ready instructions can be scheduled in a first-in first-out (FIFO) order from the ready queue. For memory access instructions encoded with load store identifiers (LSIDs), the execution order will also follow the priorities enumerated in the instruction LSIDs, or by executed in an order that appears as if the instructions were executed in the specified order. Information stored in the scoreboard 247 can include, but is not limited to, the associated instruction's execution predicate(s) (such as whether the instruction is waiting for a predicate bit to be calculated and whether the instruction executes if the predicate bit is TRUE or FALSE), availability of operands to the instruction, or other prerequisites required before issuing and executing the associated individual instruction. The number of instructions that are stored in each instruction window generally corresponds to the number of instructions within an instruction block. In some examples, operands and/or predicates are received on one or more broadcast channels that allow sending the same operand or predicate to a larger number of instructions. In some examples, the number of instructions within an instruction block can be 32, 64, 128, 1,024, or another number of instructions. In some examples of the disclosed technology, an instruction block is allocated across multiple instruction windows within a processor core. Out-of-order operation and memory access can be controlled according to data specifying one or more modes of operation.

In some examples, restrictions are imposed on the processor (e.g., according to an architectural definition, or by a programmable configuration of the processor) to disable execution of instructions out of the sequential order in which the instructions are arranged in an instruction block. In some examples, the lowest-numbered instruction available is configured to be the next instruction to execute. In some examples, control logic traverses the instructions in the instruction block and executes the next instruction that is ready to execute. In some examples, only one instruction can issue and/or execute at a time. In other examples, multiple instructions can issue and/or execute at a time. In some examples, the instructions within an instruction block issue and execute in a deterministic order (e.g., the sequential order in which the instructions are arranged in the block). In some examples, the restrictions on instruction ordering can be configured when using a software debugger to by a user debugging a program executing on a block-based processor.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core 200 until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can include graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 include a load/store queue 275, which can be used to issue memory instructions, a data cache 277, which stores data being input to or output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core 200 are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control unit 205 of the processor cores 110. The area, clock period, capabilities, and limitations substantially determine the realized performance of the individual cores 110 and the throughput of the block-based processor 100.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some cases, the scheduler 206 accepts events for target instructions that have not yet been decoded and must also inhibit reissue of issued ready instructions. In some examples, instructions can be non-predicated, or predicated (based on a TRUE or FALSE condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

Upon branching to a new instruction block, the respective instruction window(s) ready state is cleared (a block reset). However when an instruction block branches back to itself (a block refresh), only active ready state is cleared. The decoded ready state for the instruction block can thus be preserved so that it is not necessary to re-fetch and decode the block's instructions. Hence, block refresh can be used to save time and energy in loops.

### V. Example Stream of Instruction Blocks

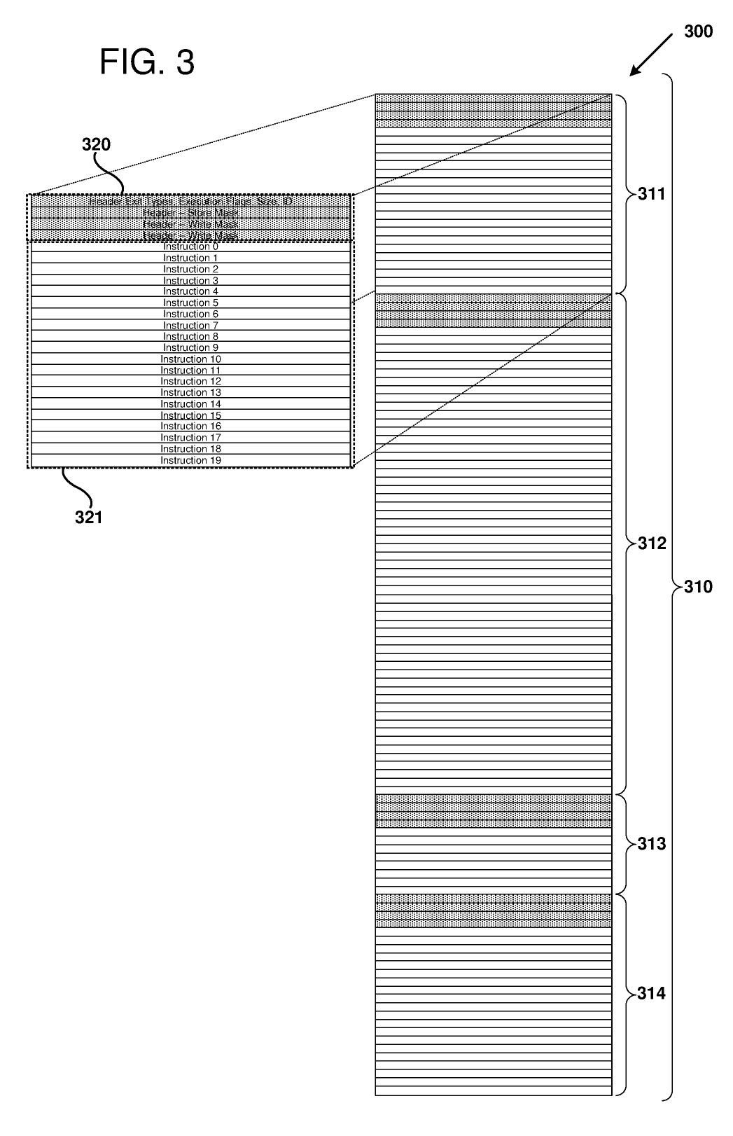

Turning now to the diagram 300 of FIG. 3, a portion 310 of a stream of block-based instructions, including a number of variable length instruction blocks 311-314 is illustrated. The stream of instructions can be used to implement user application, system services, or any other suitable use. The stream of instructions can be stored in memory, received from another process in memory, received over a network connection, or stored or received in any other suitable manner. In the example shown in FIG. 3, each instruction block begins with an instruction header, which is followed by a varying number of instructions. The portion of the instruction block with an instruction header can be referred to as the header chunk, whereas the portions of the instruction block with the actual instructions can be referred to as instruction chunks. Each instruction chunk may have a fixed size. For instance, an instruction chunk may have n instructions, and the instruction block may have m n-instruction chunks). In the example illustrated in FIG. 3, the instruction block 311 includes a header 320 in a header chunk and twenty instructions 321 in one or more instruction chunks. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include one or more execution flags that indicate one or more modes of operation for executing the instruction block. For example, the modes of operation can include core fusion operation, vector mode operation, memory dependence prediction, and/or in-order or deterministic instruction execution.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or branch processing. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The illustrated instruction block header 320 also includes a store mask that indicates which of the load-store queue identifiers encoded in the block instructions are assigned to store operations. For example, for a block with eight memory access instructions, a store mask 01011011 would indicate that there are three memory store instructions (bits 0, corresponding to LSIDs 0, 2, and 5) and five memory load instructions (bits 1, corresponding to LSIDs 1, 3, 4, 6, and 7). The instruction block header can also include a write mask, which identifies which register(s) in a register file (e.g., the register file 230 or the global register file 143, depending on the architecture) the associated instruction block will write. In some examples, the store mask is stored in a store vector register by, for example, an instruction decoder (e.g., decoder 228 or 229). In other examples, the instruction block header 320 does not include the store mask, but the store mask is generated dynamically by the instruction decoder by analyzing instruction dependencies when the instruction block is decoded. For example, the decoder can analyze load store identifiers of instruction block instructions to determine a store mask and store the store mask data in a store vector register. Similarly, in other examples, the write mask is not encoded in the instruction block header, but is generated dynamically (e.g., by analyzing registers referenced by instructions in the instruction block) by an instruction decoder and stored in a write mask register. The store mask and the write mask can be used to determine when execution of an instruction block has completed and thus to initiate commitment of the instruction block. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

Examples of suitable block-based instructions that can be used for the instructions 321 can include instructions for executing integer and floating-point arithmetic, logical operations, type conversions, register reads and writes, memory loads and stores, execution of branches and jumps, and other suitable processor instructions. In some examples, the instructions include instructions for configuring the processor to operate according to one or more of operations by, for example, speculative execution based on control flow and metadata stored in a metadata memory (e.g., metadata memory 167 or 207). In some examples, data such as the number of cores to allocate to core fusion or vector mode operations (e.g., for all or a specified instruction block) can be stored in a control register. In some examples, the control register is not architecturally visible. In some examples, access to the control register is configured to be limited to processor operation in a supervisory mode or other protected mode of the processor.

### VI. Example Block Instruction Target Encoding

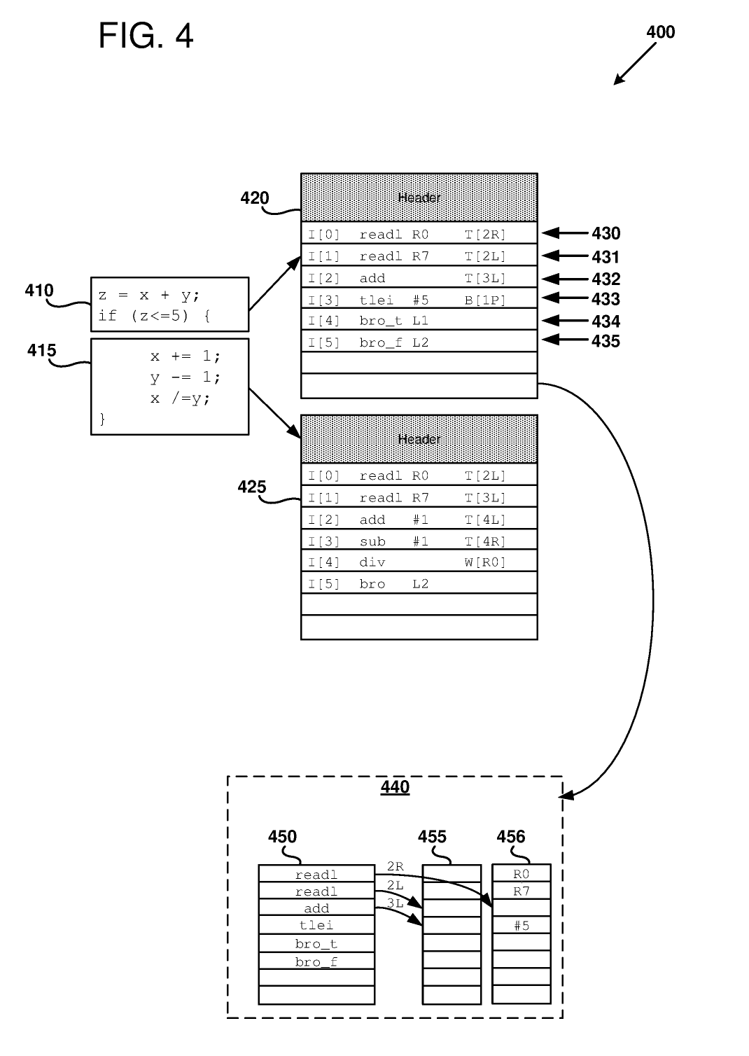

FIG. 4 is a diagram 400 depicting an example of two portions 410 and 415 of C language source code and their respective instruction blocks 420 and 425, illustrating how block-based instructions can explicitly encode their targets. In this example, the first two READL instructions 430 and 431 target the right (T[2R]) and left (T[2L]) operands, respectively, of the ADD instruction 432 (2R indicates targeting the right operand of instruction number 2; 2L indicates the left operand of instruction number 2). In the illustrated ISA, the READL instruction is the only instruction that reads from the user portion of the register file (e.g., register file 230 or global register file 143); however, any instruction can target the register file. A READH instruction is used to access the system portion of the register file. When the ADD instruction 432 receives the result of both register reads it will become ready and execute. It is noted that the present disclosure sometimes refers to the right operand as OP0 and the left operand as OP1, respectively.

When the TLEI (test-less-than-equal-immediate) instruction 433 receives its single input operand from the ADD, it will become ready to issue and execute. The test then produces a predicate operand that is broadcast on channel one (B[1P]) to all instructions listening on the broadcast channel for the predicate, which in this example are the two predicated branch instructions (BRO_T 434 and BRO_F 435). The branch instruction that receives a matching predicate will fire (execute), but the other instruction, encoded with the complementary predicated, will not fire/execute.

A dependence graph 440 for the instruction block 420 is also illustrated as an array 450 of instruction nodes and their corresponding operand targets 455 and 456 (which represent the left and right operand buffers (e.g., as shown as buffers 242 and 243 in FIG. 2). This illustrates the correspondence between the block instructions 420, the corresponding instruction window entries, and the underlying dataflow graph represented by the instructions. Here decoded instructions READL 430 and READL 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of the TLEI instruction 433.

### VII. Example Block-Based Instruction Formats

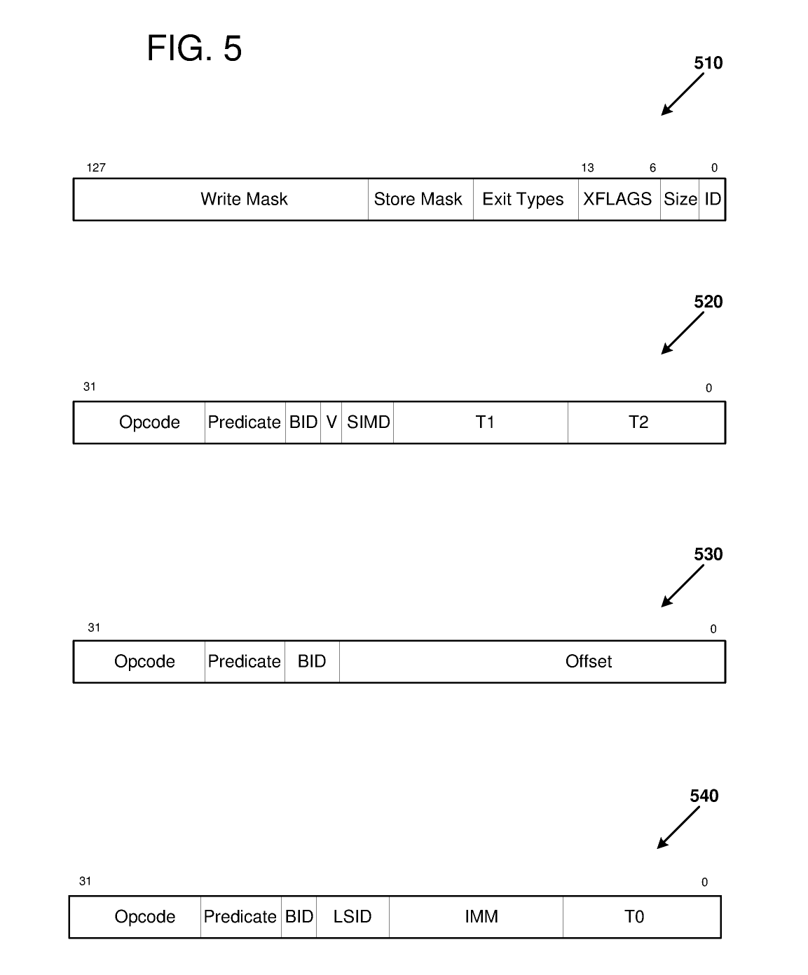

FIG. 5 is a diagram illustrating generalized examples of instruction formats for an instruction header 510, a generic instruction 520, a branch instruction 530, and a memory access instruction 540 (e.g., a memory load or store instruction). The instruction formats can be used for instruction blocks executed according to a number of execution flags specified in an instruction header that specify a mode of operation. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields, an instruction block size field, and an instruction header ID bit (the least significant bit of the instruction header).

The execution flag fields depicted in FIG. 5 occupy bits 6 through 13 of the instruction block header 510 and indicate one or more modes of operation for executing the instruction block. For example, the modes of operation can include core fusion operation, vector mode operation, branch predictor inhibition, memory dependence predictor inhibition, block synchronization, break after block, break before block, block fall through, and/or in-order or deterministic instruction execution. In some examples of the disclosed technology, bit 6 indicates vector mode operation, bit 8 indicates whether to inhibit a memory dependence predictor, and bit 13 indicates whether to force deterministic execution (e.g., execution in sequential order, or in a not-strictly sequential order that does not vary based on data dependencies or other varying operation latencies).

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a vector operation field (V), a single instruction multiple data (SIMD) field, a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “TRUE,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10, including specification of the operand slot (e.g., left operation, right operand, or predicate operand). Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of groups of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is FALSE, the instruction will not commit values calculated by the particular instruction. If the predicate value does not match the required predicate, the instruction does not issue. For example, a BRO_F (predicated FALSE) instruction will issue if it is sent a FALSE predicate value, but will not issue if it is sent a TRUE predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The memory access instruction 540 format includes an opcode field, a predicate field, a broadcast ID field (BID), a load store ID field (LSID), an immediate field (IMM) offset field, and a target field. The opcode, broadcast, predicate fields are similar in format and function as described regarding the generic instruction. For example, execution of a particular instruction can be predicated on the result of a previous instruction (e.g., a comparison of two operands). If the predicate is FALSE, the instruction will not commit values calculated by the particular instruction. If the predicate value does not match the required predicate, the instruction does not issue. The immediate field (e.g., and shifted a number of bits) can be used as an offset for the operand sent to the load or store instruction. The operand plus (shifted) immediate offset is used as a memory address for the load/store instruction (e.g., an address to read data from, or store data to, in memory). The LSID field specifies a relative order for load and store instructions within a block. In other words, a higher-numbered LSID indicates that the instruction should execute after a lower-numbered LSID. In some examples, the processor can determine that two load/store instructions do not conflict (based on the read/write address for the instruction) and can execute the instructions in a different order, although the resulting state of the machine should not be different than as if the instructions had executed in the designated LSID ordering. In some examples, load/store instructions having mutually exclusive predicate values can use the same LSID value. For example, if a first load/store instruction is predicated on a value p being TRUE, and second load/store instruction is predicated on a value p being FALSE, then each instruction can have the same LSID value.

### VIII. Example Processor State Diagram

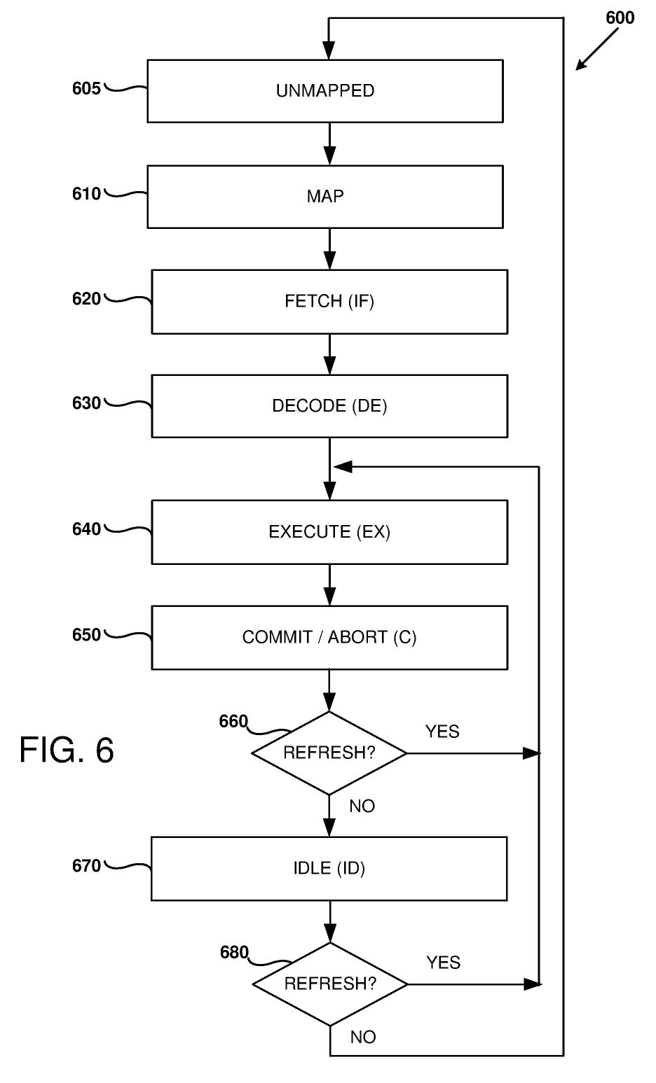

FIG. 6 is a state diagram 600 illustrating a number of states assigned to an instruction block as it is mapped, executed, and retired. For example, one or more of the states can be assigned during execution of an instruction according to one or more execution flags. It should be readily understood that the states shown in FIG. 6 are for one example of the disclosed technology, but that in other examples an instruction block may have additional or fewer states, as well as having different states than those depicted in the state diagram 600. At state 605, an instruction block is unmapped. The instruction block may be resident in memory coupled to a block-based processor, stored on a computer-readable storage device such as a hard drive or a flash drive, and can be local to the processor or located at a remote server and accessible using a computer network. The unmapped instructions may also be at least partially resident in a cache memory coupled to the block-based processor.

At instruction block map state 610, control logic for the block-based processor, such as an instruction scheduler, can be used to monitor processing core resources of the block-based processor and map the instruction block to one or more of the processing cores.

The control unit can map one or more of the instruction blocks to processor cores and/or instruction windows of particular processor cores. In some examples, the control unit monitors processor cores that have previously executed a particular instruction block and can re-use decoded instructions for the instruction block still resident on the “warmed up” processor core. Once the one or more instruction blocks have been mapped to processor cores, the instruction block can proceed to the fetch state 620.

When the instruction block is in the fetch state 620 (e.g., instruction fetch), the mapped processor core fetches computer-readable block instructions from the block-based processors' memory system and loads them into a memory associated with a particular processor core. For example, fetched instructions for the instruction block can be fetched and stored in an instruction cache within the processor core. The instructions can be communicated to the processor core using core interconnect. Once at least one instruction of the instruction block has been fetched, the instruction block can enter the instruction decode state 630.

During the instruction decode state 630, various bits of the fetched instruction are decoded into signals that can be used by the processor core to control execution of the particular instruction. For example, the decoded instructions can be stored in one of the memory stores 215 or 216 shown above, in FIG. 2. The decoding includes generating dependencies for the decoded instruction, operand information for the decoded instruction, and targets for the decoded instruction. Once at least one instruction of the instruction block has been decoded, the instruction block can proceed to execution state 640.

During the execution state 640, operations associated with the instruction are performed using, for example, functional units 260 as discussed above regarding FIG. 2. In some example embodiments, multiple instructions can be dispatched to respective functional units 260 concurrently with one another (in the same processor cycle). As discussed above, the functions performed can include arithmetical functions, logical functions, branch instructions, memory operations, and register operations. Further, depending on the operation to be performed, it may take multiple processor cycles using multiple functional units (or using multiple iterations of the same functional unit) to perform an intended operation. For example, the divide operation may take four processor cycles whereas an add or subtract operation may take two processor cycles. Control logic associated with the processor core monitors execution of the instruction block, and once it is determined that the instruction block can either be committed, or the instruction block is to be aborted, the instruction block state is set to commit/abort 650. In some examples, the control logic uses a write mask and/or a store mask for an instruction block to determine whether execution has proceeded sufficiently to commit the instruction block.

At the commit/abort state 650, the processor core control unit determines that operations performed by the instruction block can be completed. For example memory load store operations, register read/writes, branch instructions, and other instructions will definitely be performed according to the control flow of the instruction block. Alternatively, if the instruction block is to be aborted, for example, because one or more of the dependencies of instructions are not satisfied, or the instruction was speculatively executed on a predicate for the instruction block that was not satisfied, the instruction block is aborted so that it will not affect the state of the sequence of instructions in memory or the register file. Regardless of whether the instruction block has committed or aborted, the instruction block goes to state 660 to determine whether the instruction block should be refreshed. If the instruction block is refreshed, the processor core re-executes the instruction block, typically using new data values, particularly the registers and memory updated by the just-committed execution of the block, and proceeds directly to the execute state 640. Thus, the time and energy spent in mapping, fetching, and decoding the instruction block can be avoided. Alternatively, if the instruction block is not to be refreshed, then the instruction block enters an idle state 670.

In the idle state 670, the processor core executing the instruction block can be idled by, for example, powering down hardware within the processor core, while maintaining at least a portion of the decoded instructions for the instruction block. At some point, the control unit determines 680 whether the idle instruction block on the processor core is to be refreshed or not. If the idle instruction block is to be refreshed, the instruction block can resume execution at execute state 640. Alternatively, if the instruction block is not to be refreshed, then the instruction block is unmapped and the processor core can be flushed and subsequently instruction blocks can be mapped to the flushed processor core.

While the state diagram 600 illustrates the states of an instruction block as executing on a single processor core for ease of explanation, it should be readily understood to one of ordinary skill in the relevant art that in certain examples, multiple processor cores can be used to execute multiple instances of a given instruction block, concurrently.

### IX. Example Block-Based Processor and Memory Configuration

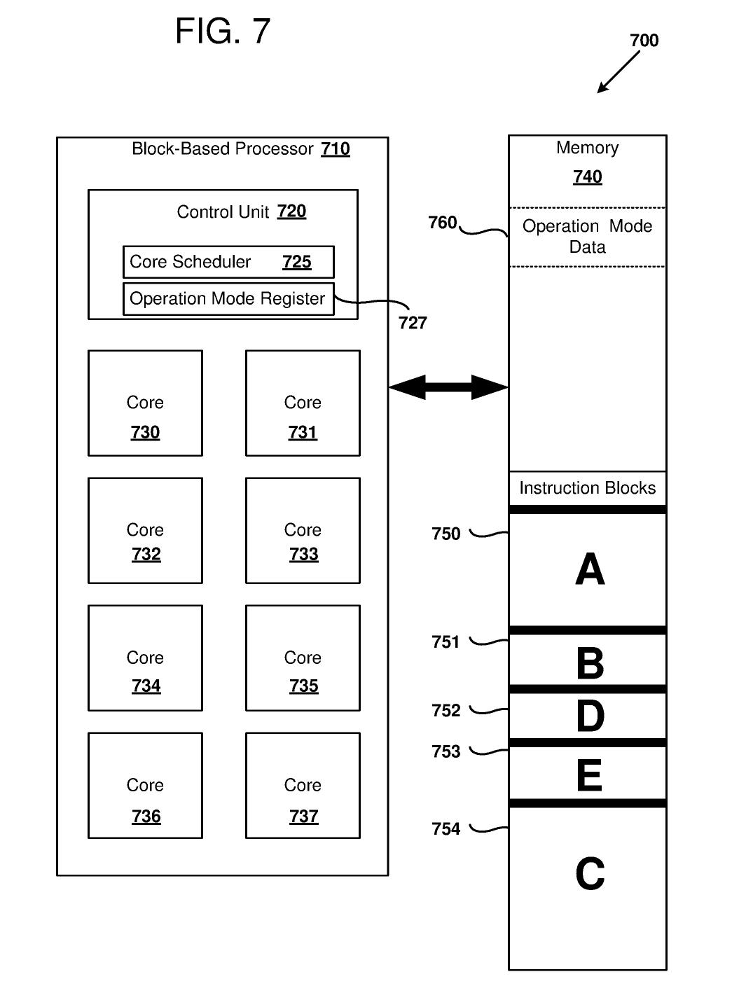

FIG. 7 is a diagram 700 illustrating an apparatus comprising a block-based processor 710, including a control unit 720 configured to execute instruction blocks according to data for one or more operation modes. The control unit 720 includes a core scheduler 725 and an operation mode register 727. The core scheduler 725 schedules the flow of instructions including allocation and de-allocation of cores for performing instruction processing, control of input data and output data between any of the cores, register files, memory interfaces and/or I/O interfaces. The control unit 720 also includes an operation mode register 727, which can be used to store data indicating one or more execution flags for an instruction block.

The block-based processor 710 also includes one or more processer cores 730-737 configured to fetch and execute instruction blocks and a control unit 720, when a branch signal indicating the target location is received from one of the instruction blocks. The illustrated block-based processor 710 has up to eight cores, but in other examples there could be 64, 512, 1024, or other numbers of block-based processor cores. The block-based processor 710 is coupled to a memory 740 which includes a number of instruction blocks 750-755. In some examples of the disclosed technology, an operation mode data table 760 can be stored in memory, or built dynamically at run time, to indicate operation mode(s) for executing the instruction blocks 750-754, in lieu of, or in addition to, the operation mode register 727.

### X. Example Method of Configuring Processor for Executing an Instruction Block

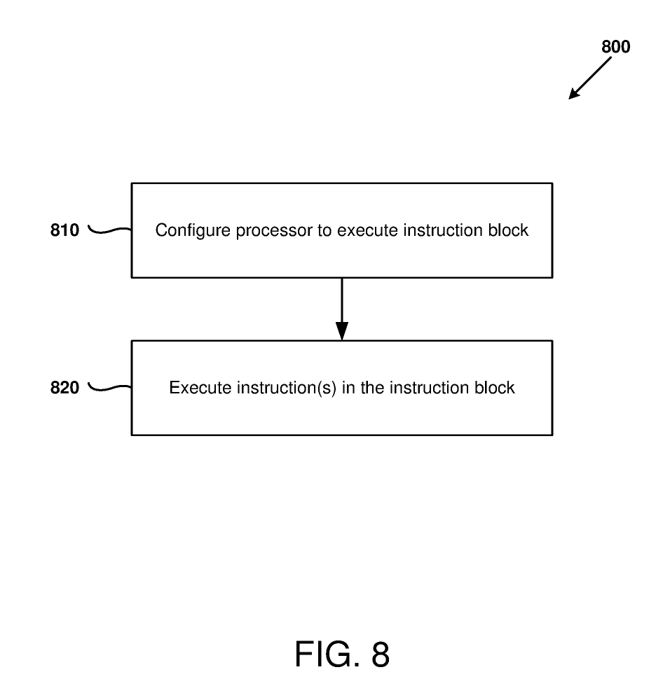

FIG. 8 is a block diagram 800 outlining an example method of configuring a processor to operate according to instructions from an instruction block, as can be performed in certain examples of the disclosed technology. For example, the block-based processor 100 described above, can be configured to perform the method of FIG. 8.

At process block 810, the processor is configured to execute an instruction block. For example, an instruction block header can be decoded for a block-based processor instruction block that includes one or more fields defining semantics of the instruction block. The processor then configures at least one of its processor cores to execute instructions in the instruction block according to the header fields. The modes of operation that can be configured by the header include, but are not limited to: core fusion operation, vector mode operation, memory-dependence prediction operation, or in-order execution operation. In some examples, when at least one of the specified modes is a core fusion operation, the field corresponding to the specified mode can indicate a number of cores of the block-based processor to allocate to execute of the associated instruction block. In some examples, the core is configured to execute instructions according to two or more operation modes. For example, the core can be configured to perform core fusion operations and to enable or disable memory dependence prediction. Alternatively, for example, the processor can be configured for core fusion operation and in-order execution operations. In some examples, data indicating one or more of the specified operation modes can be stored in a location other than an instruction block header, for example by executing a particular instruction of an instruction block, by storing a value in a designated register or memory location, or other suitable means for providing data indicating the operation mode. Once the processor is configured to execute the instruction block, the method proceeds to process block 820.

At process block 820, the instructions in the instruction block are executed according to the operation mode selected at process block 810. For example, one or more of the processor cores depicted in FIG. 1, 2, or 7 can be configured to execute any of the instructions discussed herein according to the instruction header fields which can include, but are not limited to, core fusion operation, vector mode operation, memory-dependence prediction operation, and/or in-order execution operation.

### XI. Example Method of Generating Block-Based Executable Instructions

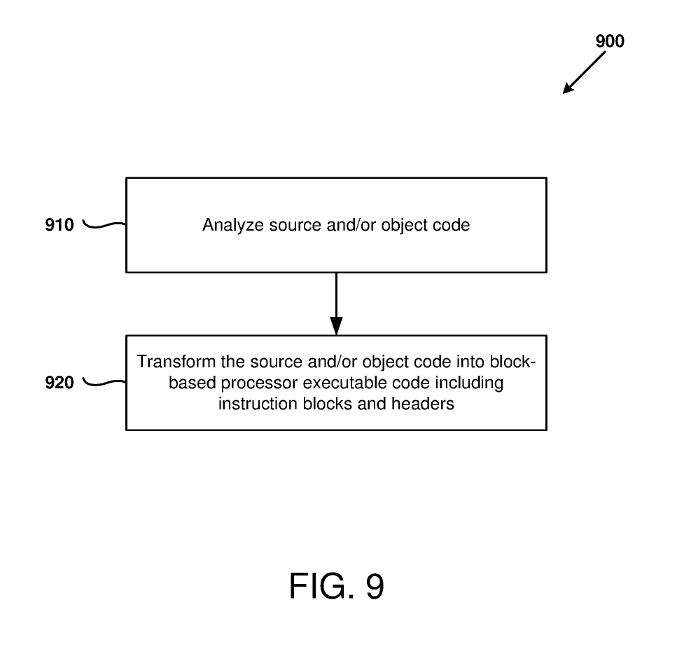

FIG. 9 is a flowchart 900 outlining a method of compiling source and/or object code into executable code for a block-based processor, as can be performed in certain examples of the disclosed technology. For example, the method can be performed using a block-based processor, or a general-purpose processor that includes instructions for performing the disclosed method.

At process block 910, source code and/or object code for a block-based processor is analyzed with a compiler.

At process block 920, source code and/or object code is transformed into block-based processor executable code based on the analysis performed at process block 910. In some examples, the code is determined automatically by the compiler. In other examples, the code is determined, at least in part, by directives provided by the programmer of the instruction block code. For example, options within an integrated development environment, compiler pragmas, defined statements, and/or key words located in comments within source code can be used to, at least in part, indicate operation modes.

In some examples, the compilation flow of FIG. 9 can further include an analysis of the source and/or object code to determine operations in conditional paths to re-arrange. Such analysis can cause the compiler to generate instructions that cause the block-based processor to pre- pre-compute the operation(s) while also ensuring that the pre-computed results are only used as final results upon satisfaction of the appropriate predicate condition. Example embodiments of such instruction rearrangement (modification) as can be performed in connection with read instruction are discussed in more detail below. Still further, in certain implementations (e.g., for architectures that use a write mask and/or store mask to control instruction block commitment), the compiler is also responsible for balancing the write and/or store instructions in the resulting block-based processor executable instructions (e.g., by using appropriate NULL instructions, or by nullifying unexecuted write and/or store instructions). Examples of such balancing are discussed in more detail below.

The executable code generated by transforming source and/or object code can be stored in a computer-readable storage medium. In other examples, the executable code is provided to a processor as part of an instruction stream (e.g., by sending executable instructions over a computer network, or by interpreting code written in an interpretive language locally).

### XII. Examples of Generating and Using Predicated Read Instructions

As explained above, certain embodiments of the disclosed technology comprise a block-based processor that executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In particular example implementations, the instruction format for such a block-based processor (e.g., EDGE ISA architecture) may not natively allow an instruction for an arithmetic or logic operations to directly reference a register (or multiple registers) in order to specify the operands for the operation, all within a single instruction. Likewise, the instruction format may not natively allow an instruction for an arithmetic or logic operations to directly reference a register (or multiple registers) to which the result of the operation is to be stored. Instead, in embodiments of the disclosed technology (e.g., an EDGE ISA architecture), the arithmetic and logic operations are triggered by instructions for the arithmetic and logic operation that wait to receive the operands from one or more other instructions, and once all necessary operands (potentially including predicate operands) are available for a particular instruction, the operation specified by the instruction can issue and be executed. Further, the operation's result is then sent to the target specified in the target field of the instruction for the operation. To allow for the retrieval of values from the registers used in the block-based processor architecture (e.g., an EDGE ISA architecture), the instruction set used with example processors of the disclosed technology includes a read instruction, which when executed causes a processor core to read a value from a register (e.g., a particular register in the register file 230) and send it for use by another instruction in the instruction block (e.g., by loading the value into one or more target operands, including LOP buffer 242, ROP buffer 243, or predicate buffer 244 for a particular instruction, or by broadcasting it on an available broadcast channel 245 to a plurality of target instructions).

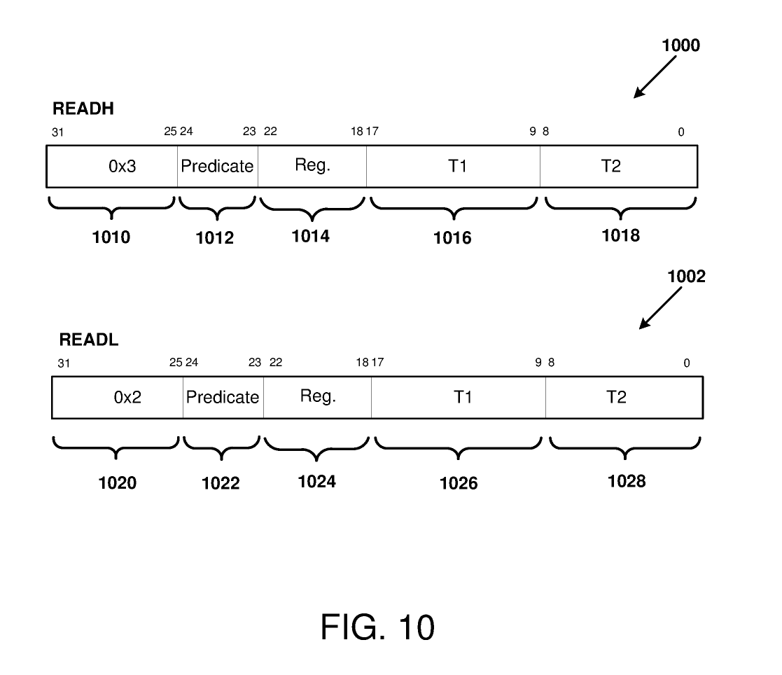

Further, in embodiments of the disclosed technology (such as the examples discussed below with respect to FIGS. 10-19), the read instructions are actual instructions that are used in an instruction chunk of the instruction block (not header data or data to be used in the header chunk of the instruction block). This approach greatly increases the flexibility in the amount of data used for reads relative to an approach that reserves space for all possible reads in the header chunk of the instruction block. Typically, with this approach (where read instructions are used as actual instructions), the bits required for reads will be reduced. The flexibility of this approach also allows any number of instructions in the instruction chunks to be used as read instructions, which allows for the number of read instructions to exceed the space in the header if needed. Still further, with this approach, a read instruction will be fetched and decoded along with other instructions in the instruction chunks at different times depending on block execution. This is in contrast to an approach where reads are queued and decoded en masse (such as when reads are metadata in the header chunk of the instruction block and fetched/decoded together).

FIG. 10 shows two example formats 1000, 1002 for read instructions. In general, read instruction 1000 is a READH instruction for accessing a certain portion of the register file 230 or general register file 143 (here, a high bank of 64 registers labeled R0-R63), whereas the read instruction 1002 is a READL instruction for accessing another portion of the register file 230 or general register file 143 (here, a lower bank of 64 registers also labeled R0-R63). In some examples, certain registers (e.g., the low bank of 64 registers) can be accessed during all modes of processor operation (e.g., user mode and supervisor mode) while certain registers (e.g., the high bank of 64 registers) can only be accessed from certain modes of processor operation (e.g., only in supervisor mode). In other examples, register labels do not overlap, but only certain registers can be accessed, depending on the particular mode. In some examples, certain registers can be read, but not written to, depending on the current mode of processor operations. In some implementations, the register file may be divided into a portion for system data and a portion for user data, and the instructions 1000, 1002 may be specific to a respective one of the portions (e.g., the READH instruction 1000 for the system portion, and the READL instruction 1002 for the user portion). The particular formats illustrated should not be construed as limiting, however, as the fields presented can be arranged in different order and/or with different numbers of bits per field. Further, although only two target fields are illustrated (T1, T2), the instruction can have any number of target fields, depending on the architecture.

Referring first to example READH instruction 1000, the opcode field 1010 includes a particular operational code (here, the 7-bit hexadecimal value 0x3) uniquely specifying the instruction as the READH instruction. The predicate field 1012 specifies the condition under which the instruction will execute. For example, the predicate field can specify the value “TRUE,” and the instruction will only execute if a corresponding condition flag matches the specified predicate value. In some examples, the predicate field specifies, at least in part, which value (e.g., “TRUE” or “FALSE”) is used to compare to the predicate, while in other examples, the execution is predicated on a flag set by a previous instruction (e.g., the preceding instruction in the instruction block). In some examples, the predicate field can specify that the instruction will always be executed, never be executed, executed on a predicate of “TRUE,” or executed on a predicate of “FALSE”. Thus, use of the predicate field can allow for denser object code, improved energy efficiency, and improved processor performance, by reducing the number of branch instructions. The register field 1014 specifies the register in the register file (e.g., in the relevant portion of the register file, such as the higher-addressed registers) whose value is to be retrieved. In the illustrated embodiment, the register field 1014 specifies a 5-bit number identifying the register from the upper 32 registers of the register file 230 whose value is to be retrieved. As noted, the registers in the register file 230 can be multi-bit registers (e.g., 64-bit registers or any other larger or smaller register size). The target fields 1016 (T1) and 1018 (T2) specify the targets to which the retrieved values from the register are sent. The targets can be one or more of another instruction (in which case the target specification includes information about whether the value is to be used as the left operand, right operand, or predicate operand for the instruction), a broadcast channel, a register to which the result is to be written, or a memory location to which the result is to be stored. For example, for a READH instruction at instruction slot 5, the target fields can specify that the register value retrieved is sent to instructions at slots 3 and 10, including specification of the operand slot (e.g., left operation, right operand, or predicate operand). Referring to the example architecture in FIG. 2, for instance, execution of such a READH instruction will retrieve the specified value from the register file (e.g., register file 230 or general register file 143) and buffer the value in the LOP buffer 242, ROP buffer 243, or predicate buffer 244 corresponding to the target specified in the instruction.

With respect to the example READL instruction 1002, the, the opcode field 1020 includes the particular operational code (here, 0x2) uniquely specifying the instructions as the READL instruction. The predicate field 1022, register field 1024, and target fields 1026 (T1) and 1028 (T2) operate in the same fashion as described above with respect to the READH instruction. The general register field 1024, however, specifies a register in the lower part of the register file (e.g., from the lower bank of 64 registers in the register file).

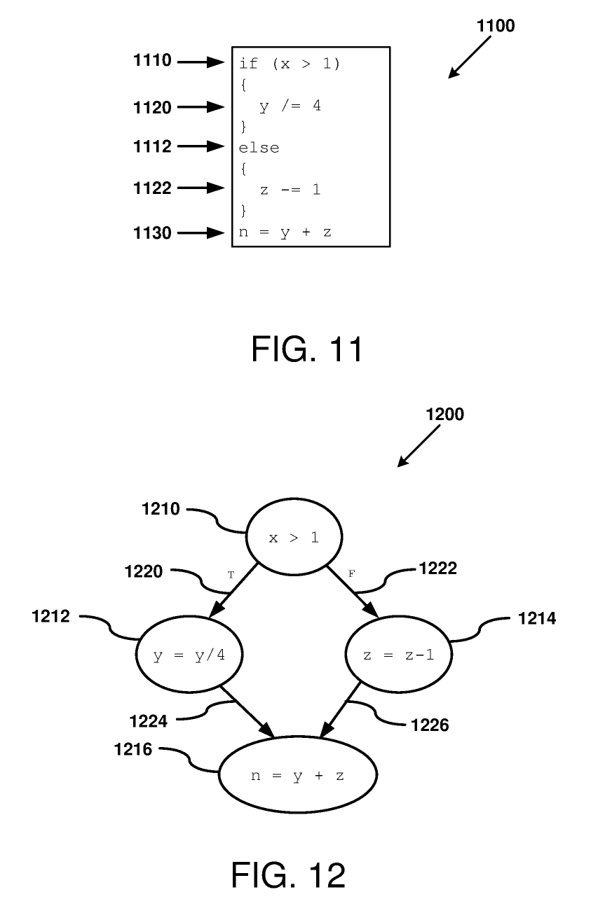

FIGS. 11-15 show example applications of how source code can be transformed into block-based processor executable instructions that incorporate read instructions as discussed above.

More specifically, FIG. 11 is a block diagram showing example source code 1100. The source code 1100 may be part of a larger program or program module. The example source code 1100 includes conditional IF/ELSE statements 1110, 1112 that are predicated on the condition of whether variable x is greater than 1. If so, then at 1120 variable y is divided by 4; if not, then at 1122 variable z is decremented by 1. Finally, the source code 1100 includes an assignment statement 1130 that assigns variable n the sum of y and z.

The source code 1100 can be compiled by a specialized compiler adapted to generate block-based processor-executable instructions for execution using any of the disclosed block-based processors disclosed herein. During compilation, a data flow graph can be generated that represents the data and/or control flow of the source code. For example, in particular embodiments, a directed acyclic graph (DAG) is generated as an intermediate representation during compilation and used at least in part during generation of the final processor instruction set.

FIG. 12 is a block diagram illustrating an example control data flow graph 1200 for the source code 1100. Such a control data flow graph can be generated during compilation as an intermediate representation of the source and/or object code. As can be seen, the control data flow graph 1200 includes a series of nodes 1210, 1212, 1214, 1216 connected by vertices 1220, 1222, 1224, 1226. Node 1210 is a node associated with the IF statement 1110 for determining the condition of whether variable x is greater than 1 (x>1). Traversal of vertice 1220 requires the conditional value to evaluate to “TRUE” (illustrated by condition “T” on the vertice 1220), whereas vertice 1222 requires the conditional value to evaluate to “FALSE” (illustrated by condition “F” on the vertice 1222). Thus, the vertices 1220, 1222 form two conditional paths predicated on the condition specified in the node 1210. Along the “TRUE” path, node 1212 performs a division operation to variable y; in particular, node 1212 is associated with variable y being divided by 4. Along the “FALSE” path, node 1214 performs a decrementing operation to variable z; in particular, node 1214 is associated with variable z being decremented by 1. Node 1216 is a join node for an operation that is performed upon completion of the operations in the conditional paths shown in nodes 1212 or 1214. In particular, node 1216 is associated with the variable n being assigned a value equal to the sum of variables y and z.

As can be seen in FIG. 12, the operations at nodes 1212, 1214 are only performed upon determination of the conditional value at node 1210. Thus, in accordance with the data flow graph of FIG. 12, the operations at nodes 1212, 1214, and 1216 are not performed until after the conditional value of node 1210 is determined.

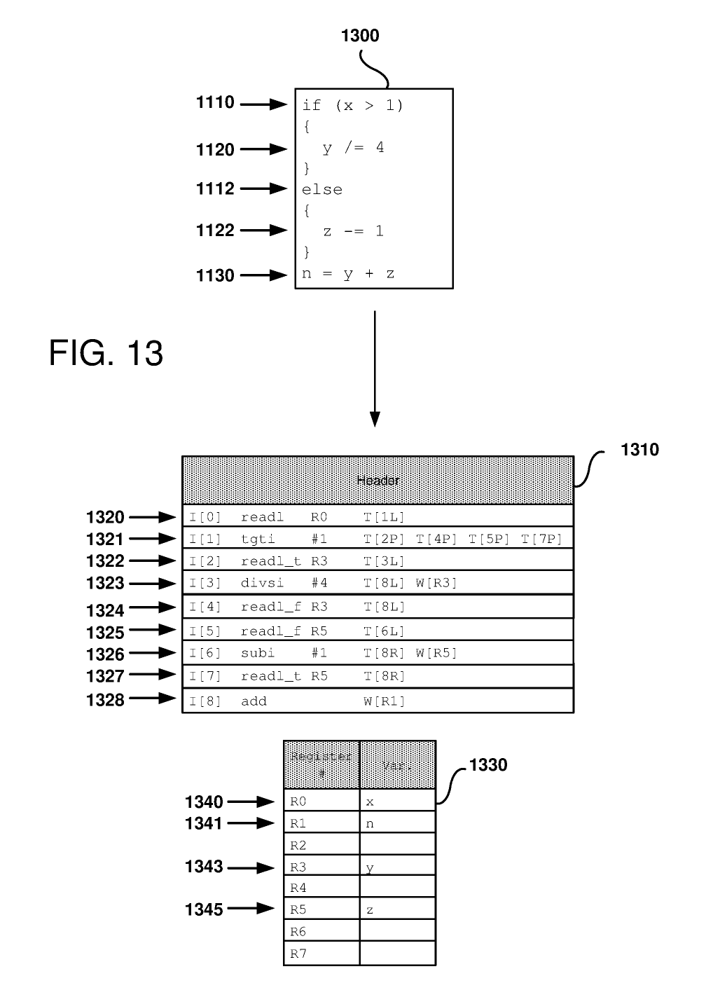

FIG. 13 is a block diagram illustrating an example conversion into block-based processor executable instructions of the source code in FIG. 11. Source code 1300 again shows the source code 1100. Instruction block 1310 illustrates exemplary instructions for execution by, for example, a block-based processor in accordance with the disclosed technology. The instructions in the instruction block 1310 include read instructions as discussed above that enable the data retrieval and targeting used to perform the desired operations specified by the source code. Also shown in FIG. 13 is a representation of register file 1330, which shows the register IDs for eight registers, though it should be understood that additional (or fewer) registers may be present in the register file 1330.

In detail, instructions 1320 and 1321 together implement the evaluation of the condition (x>1)) specified by the IF statement 1110. In particular, instruction 1320 is a read instruction READL to retrieve the value of the variable x from its relevant register, here register R0. Instruction 1320 also targets the instruction at slot 1 and specifies that the value is to be used as the left operand, shown by “T[1L]” where “1” is the instruction slot and “L” is the operand location. Instruction 1321 is an instruction TGTI for performing a less than or equal operation comparing its left operand to a specified value, here the integer “1” as shown by “#1”. Instruction 1321 sends its results as the predicate for multiple target instructions—namely, the instructions at instruction slot 2, 4, 5, and 7 (as shown by “T[2P]”, “T[4P]”, “T[5P]”, and “T[7P]”).

Although four targets are shown for instruction 1321, the number of available targets may be more limited, such as two targets, depending on the processor architecture. In such cases, the targets of the instruction 1321 could be instructions that serve to copy (or move) a received operand to two additional targets (e.g., two move instructions MOV that copy a received operand to one or two further targets), and thus effectively allow the operand to be fanned out to as many instructions as desired (e.g., instruction 1321 could target two move instructions that each individually copy the operand to two additional slots, thus allowing four instruction slots total to be targeted). Or, two TGTI instructions could be used to perform a less than or equal to operation, each targeting two of the desired four targets (e.g., a first TGTI instruction could target instruction slots 2 and 4, and a second TGTI instruction could target instruction slots 5 and 7).

The conditional paths for the source code 1100 (illustrated in the data flow graph 1200 as nodes 1212, 1214) are conditioned on the IF statement 1110, and will be performed by instructions 1322, 1323, 1324 if the statement 1110 evaluates to “TRUE” path (node 1212), or will be performed by instructions 1325, 1326, 1327 if the statement 1110 evaluates to “FALSE” path (node 1214). In particular, instructions for each conditional path begin execution using a predicated read instruction, as described above. Instruction 1322 is a predicated read instruction READL_T predicated on its predicate being “TRUE”. The predicate for performing the instruction is shown by the logic value after the underscore following the instruction—namely, “_T” for “TRUE”. Thus, predicated instruction 1322 only executes once the predicate value becomes available and when the predicate value is “TRUE”. If the predicate condition is satisfied, the READL_T instruction 1322 reads the value of register R3, which here corresponds to variable y, and sends it to instruction slot 3 as the left operand for that instruction. With its operand now available for execution, DIVSI (divide signed immediate) instruction 1323 will perform a signed division operation on the operand by a specified immediate value, here the number “4” as specified by “#4”. Further, instruction 1323 sends the result to instruction slot 8 as the left operand for that instruction (T[8L]). Instruction 1323 also writes the new value of y to register R3 (W[R3]), thus updating the value of y in register R3 when the instruction block commits. It should be noted that if the predicate value is “FALSE”, then instruction 1323 will never issue, because not all of its dependencies (here, the instructions's right operand) are available, because instruction 1322 did not execute, based on the false predicate value. This is the case even though instruction 1323 is encoded as an unpredicated instruction. Instruction 1324 is an instruction that will execute in the situation when the predicate condition is “FALSE”, in which case the value for variable y should still be sent to instruction slot 8 as the left operand, but without any division by 4. In particular, instruction 1324 is a predicated read instruction READL_F that specifies that the value of register R3 (variable y) should be retrieved and sent to instruction slot 8 if the predicate is “FALSE” (T[8L]).

Turning to the second conditional path, instruction 1325 is a predicated read instruction READL_F predicated on its predicate being “FALSE”. Thus, instruction 1325 only executes once the predicate value becomes available and when the predicate is “FALSE”. If the predicate condition is satisfied, the instruction 1325 reads the value of register R5, which here corresponds to variable z, and sends it to instruction slot 6 as the left operand for that instruction (T[6L]). With its operand now available for execution, instruction 1326 will perform a decrementing operation (subi) by a specified value, here “1” as specified by “#1”. Further, the result of the decrementing operation is sent to instruction slot 8 as the right operand (T[8R]). Instruction 1326 also writes the new value of z to register R5 (W[R5]), thus updating the value of z in register R5. Instruction 1327 is an instruction that accounts for the situation when the condition is “TRUE”, in which case the value for variable z should still be sent to instruction slot 8 as the right operand, but without any division by 4. In particular, instruction 1327 is a predicated read instruction READ_T that specifies that the value of register R5 (variable z) should be retrieved and sent to instruction slot 8 if the predicate is “FALSE” (T[8R]), but without any decrementing.

Instruction 1328 performs the addition of variables y and z after completion of the computations performed along the conditional paths. In particular, once its left and right operands are available, ADD instruction 1328 performs an add operation of those two operands. ADD instruction 1328 further includes as its target a write operation to a register (R1) in the register file (W[R1]), where R1 corresponds to the register for variable n (e.g., instead of another instruction as a target).

In some embodiments of the disclosed block-based processor architecture, a write mask and a store mask are included in the instruction block and include an indication of the registers that will be written to, and an indication of which memory instructions will write to memory, during execution of the instruction block. Thus, as the various write or store operations in the instruction block occur, their execution can be tracked. In certain implementations, the control unit for a processor block does not commit an instruction block until all writes and stores indicated by the write and store masks have occurred. Thus, if there is a write operation in a conditional path for a TRUE predicate that does not occur in the conditional path for the FALSE predicate (or vice versa), the control unit for the processor core may prevent the instruction block from being committed when the predicate is FALSE because the write operation will not occur. To alleviate this possibility, certain embodiments of the disclosed technology use NULL write and NULL store instructions to balance the number of writes and stores along each conditional path, thus guaranteeing that all writes and stores identified in the write and stores masks will be accounted for upon traversal of any of the conditional paths. In more detail, the NULL write instruction can specify a particular register ID as its target and can be predicated. Further, the NULL write instruction is recognized by the control unit as a valid write instruction but will not actually perform a write operation to the targeted register. The NULL store instruction operates similarly but for a targeted memory location. In the example shown in FIG. 13, then, two null operations could be added to the instruction block to balance the write operations in each path: “I[9] null_t W[R5]” (to place a write operation to R5 in the TRUE path) and “I[10] null_f W[R3]” (to place a write operation to R3 in the FALSE path). Further, the targets for I[1] (which computes the condition) would be modified to include the predicates for new instructions I[9] and I[10].

Conditional paths in source code often present the opportunity for the compiler to improve overall processor performance by recognizing paths that are more likely to be followed and by generating processor executable instructions that perform the operations in those paths in a different than specified by the source code (e.g., before or while the condition on which the path depends is being computed). For instance, in embodiments of the disclosed technology, the processor is typically capable of performing multiple operations at least partially concurrently with one another. Consequently, if the processor can compute values for a conditional path before or at least partially simultaneous with the computation(s) that determine the condition for that path, the overall number of processor cycles can be reduced for the situations where the condition for the path is satisfied. Additionally, earlier execution of operations from a conditional path can help reduce fanout that would otherwise occur during execution of a conditional path. As one example, the source code may include a complex operation that occurs in both conditional paths, in which case the earlier execution of the operation can reduce the size of the instruction block and allow for improved computational efficiency in terms of speed, memory, and power during execution of the instruction block.

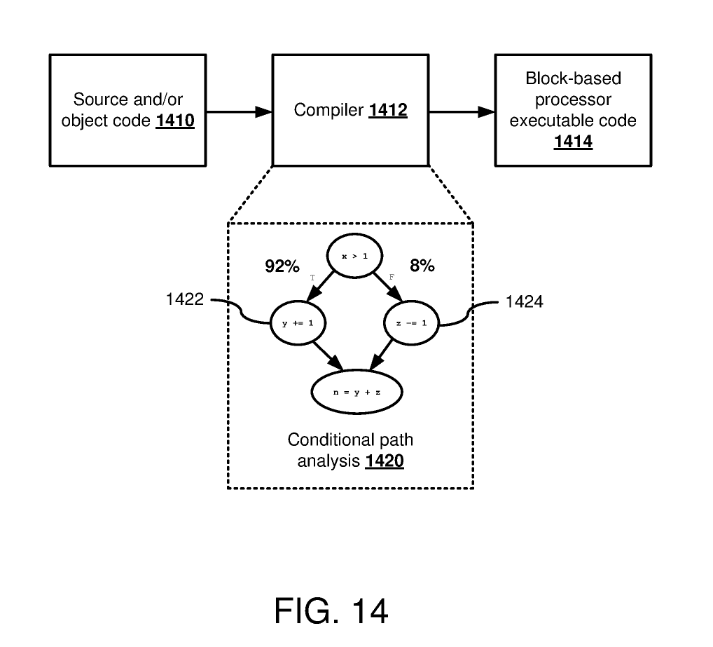

FIG. 14 is a block diagram 1400 illustrating an example compilation flow for performing embodiments of the disclosed technology. The example compilation flow can be performed using a block-based processor, or a general-purpose processor that includes instructions for performing the disclosed method. In particular, FIG. 14 shows source and/or object code 1410 that is to be compiled for use in a block-based processor architecture. The source and/or object code 1410 is input (e.g., buffered into memory or otherwise prepared for further processing) into compiler 1412. Compiler 1412 performs compilation of the code and generates block-based processor executable code 1414, which typically comprise the instructions to be executed in each processor core (e.g., the instructions used in the instruction windows 210, 211). During compilation, the compiler 1412 is tasked with appropriately dividing the operations specified by the source and/or object code 1410 in a manner that allows for proper execution by the processor cores of the architecture. Further, in certain implementations (e.g., for architectures that use a write mask and/or store mask to control instruction block commitment), the compiler is also responsible for balancing the write and/or store instructions in the resulting block-based processor executable instructions (e.g., by using appropriate NULL instructions).

In certain embodiments, the compiler also operates to evaluate and implement possible enhancements that improve processor performance during instruction execution (e.g., by reducing the overall number of cycles used to perform block execution, reducing the number of instructions used to perform operations, reducing power during processor operation, or other improvements to computational efficiency). For example, and as explained in the previous paragraph, it is sometimes more computationally efficient to execute at least some of the operations in a conditional path (and, for example, temporarily store or buffer the intermediate result) prior to or simultaneous with the condition for the path being determined. Such improved efficiency can result, for instance, in situations where the operation(s) of a path are computationally intensive (e.g., use 3 or more cycles), where the path is more likely than not going to be executed, and/or where the processor is capable of performing multiple operations at one time. Because of the multi-operation capability of a processor, for instance, the processor can perform operations for the path at the same time it determines the condition or, in some cases and depending on the source/object code, before the condition is determined. As noted above, such improved efficiency can also be the result of reducing the fanout of instructions in the instruction block.

To implement such enhancements, the example compiler 1412 illustrated in FIG. 14 performs an analysis 1420 during compilation to identify and implement instances where the operations from a conditional path of the code can be executed earlier than specified in the source/object code in order to obtain processor efficiency, power, and/or memory improvements. The analysis 1420 can comprise profiling the program (e.g., by inserting instrumentation into the source code or instrumenting the data flow graph) and then evaluating the program to determine how often a path is expected to executed (e.g., using simulation, static analysis, event-based analysis, statistical approaches, or other methodology for evaluating program performance). For example, and as illustrated in FIG. 14, the conditional paths for the code of FIG. 11 can be evaluated to determine how often each conditional path is expected to execute. In the illustrated example, path 1422 (triggered when condition “x>1” is TRUE) is expected to occur 92% of the time, whereas path 1424 (triggered when condition “x>1” is FALSE) is expected to occur 8% of the time. The information from the profiling can then be used by the compiler 1412 to determine whether any enhancements can be made to the block-based processor executable code to improve processor performance.

Continuing with the example from FIG. 14, one or more operations associated with the conditional path 1422 can be re-located within the instruction block (e.g., in order to have the operations executed earlier). For example, the instructions that are re-located can be made unpredicated. Further, the instructions that are re-located can target a predicated instruction that ensures that the result of the one or more operations is only used when the appropriate condition is satisfied. For example, the re-located instructions can target a predicated MOVE instruction that serves to “guard” against misapplying the pre-computed value.

When instructions are re-located or ordered to occur earlier then when they would normally appear, such action is sometimes referred to as “hoisting” the instruction. Furthermore, the conditional path that is more likely to occur is sometimes termed the “hot path”, and its operations are subject to hoisting by the compiler. Furthermore, the threshold for performing hoisting by the compiler may vary from implementation and depend on various factors and trade-offs (e.g., the number of parallel conditional paths under consideration, the complexity of the operations performed along its respective conditional path, etc.). In general, however, the compiler 1412 can use thresholds that favor hoisting operations that are more likely than not going to be performed (e.g., >50% probability) and/or that favor hoisting complex operations over simple operations (e.g., hoisting operations that use 3 or more processor cycles relative to operations that use less than 3 processor cycles).

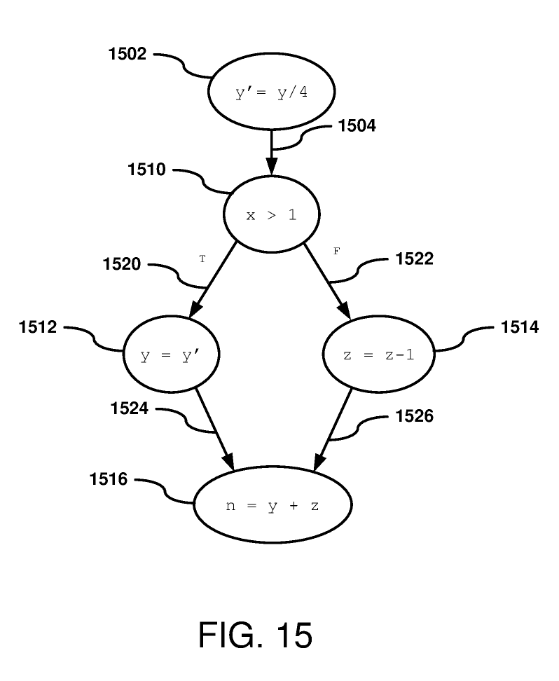

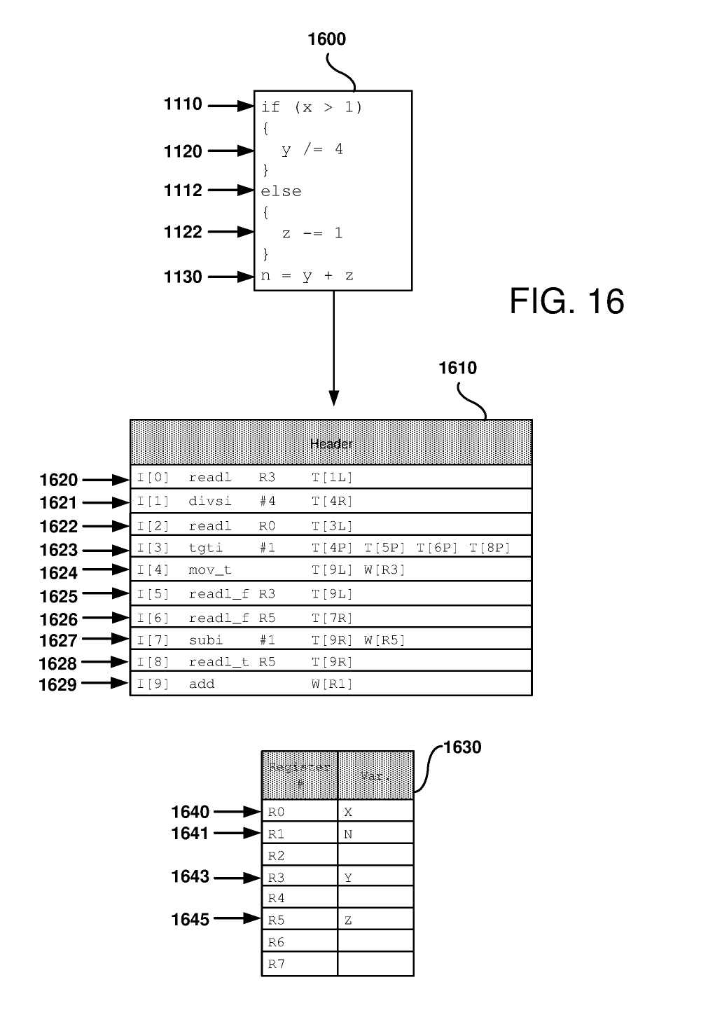

To illustrate an example result from such hoisting, FIG. 15 is a block diagram illustrating an example data flow graph 1500 for the source code 1100 after hoisting is performed. The data flow graph 1500 includes a series of nodes 1502, 1510, 1512, 1514, 1516 connected by vertices 1504, 1520, 1522, 1524, 12526. After hoisting, node 1502 is a node associated with the division operation of variable y by a value of 4. In the illustrated embodiment, the result of this operation is stored in a temporary variable, denoted here as y′ (y prime). Thus, node 1502 represents the earlier (“hoisted”) performance of the division operation of line 1120 of the source code, and thus the earlier performance of an operation from a conditional path. Following node 1502 is node 1510, which is a node associated with the IF statement 1110 for determining the conditional value of whether x is greater than 1 (x>1). Traversal of vertice 1520 requires the conditional value to evaluate to “TRUE” (illustrated by value “T” on the vertice), whereas vertice 1522 requires the conditional value to evaluate to “FALSE” (illustrated by value “F” on the vertice). Thus, the vertices 1520, 1522 form part of two conditional paths that are predicated on the condition specified in the node 1510. Along the “TRUE” path, node 1512 performs a computationally simple assignment operation that assigns the value of the temporary variable y′ computed at node 502 to the variable y. In other words, because the condition on which the hoisted computation depended is found to have occurred, node 1512 is for an operation that copies the hoisted computed value to the variable that was expected to become the value. Along the “FALSE” path, node 1514 performs a decrementing operation to variable z; in particular, node 1514 is associated with variable z being decremented by 1. Node 1516 is a join node for an operation that is performed upon completion of the conditional operation shown in either node 1512 or 1514. In particular, node 1516 is associated with the variable n being assigned a value equal to the sum of variables y and z.

As can be seen in FIG. 15, the operation at node 1502 is performed earlier than originally specified (e.g., earlier or concurrently with the determination of the condition on which the operation depends). During execution by the processor core of a block-based processor, the computation for node 1502 may be performed before or at the same time as the computation of node 1510 (e.g., if the processor can perform multiple operations in a single processor cycle, the two operations (along with any other pre-condition-determination operations) can be performed at least partially during overlapping processor cycles.

FIG. 16 is a block diagram illustrating an example conversion into block-based processor executable instructions of the source code in FIG. 11 where hoisting (hoisting of operations in conditional paths) is performed in accordance with embodiments of the disclosed technology. Source code 1600 again shows the source code 1100. Instruction block 1610 illustrates exemplary instructions for execution by, for example, a block-based processor in accordance with the disclosed technology. The instructions in the instruction block 1610 represent example instructions that can be generated by a compiler after an analysis to identify instructions that can be hoisted is performed, as described above. In this case, and as illustrated in FIG. 14, the “TRUE” path for the “x>1” condition is highly likely to be executed, and thus is selected for hoisting by the compiler during generation of the processor-executable instructions. Also shown in FIG. 16 is a representation of register file 1630 (e.g., which can be part of a register file 230 or general register file 143), which shows the register IDs for eight registers, though it should be understood that additional (or fewer) registers may be present in the register file 1630.

In detail, instructions 1620, 1621 are responsible for performing the hoisted division operation in line 1120 of the source code 1600. In particular, an unpredicated read instruction is used, as described above (and not a predicated read, as the instruction is no longer to wait for execution until determination of its predicate). The instruction 1620 reads the value of register R3, which here corresponds to variable y, and sends it instruction slot 1 as the left operand for that instruction. With its operand now available for execution, instruction 1621 will perform a division operation on the operand by a specified value, here the number “4” as specified by “#4”. Further, instruction 1621 sends the result to instruction slot 4 (instruction 1624) as the left operand for that instruction. The instructions 1620, 1621, however, do not result in a write operation to a particular register; instead, the value from the division operation in instruction 1621 is sent to a buffer for instruction 1624, which may or may not be executed depending on the condition x>1. In this way, the new value for y is maintained as a temporary value (corresponding to y′ (y prime) in FIG. 15).

Instructions 1622 and 1623 together implement the evaluation of the condition (x>1)) specified by the IF statement 1110. In particular, instruction 1622 is a read instruction to retrieve the value of the variable x from its relevant register, here register R0. Instruction 1622 also targets the instruction at slot 3 (instruction 1623) and specifies that the value is to be used as the left operand. Instruction 1623 is an instruction TGTI for performing a less than or equal operation using its left operand and comparing that value to a specified value, here the integer “1” as shown by “#1”. Instruction 1623 sends its results as the predicate for multiple target instructions—namely, the instructions at instruction slot 4, 5, 6, and 8. As noted above, the number of available targets may be more limited, and move instructions or multiple instances of the less than or equal to instruction could be used to achieve the desired fan out of predicate values.

The conditional paths for the source code 1100 and as illustrated in the data flow graph 1500 are performed by instructions 1624, 1625 for the “TRUE” path (node 1512), and instructions 1626, 1627, 1628 for the “FALSE” path (node 1514). Instruction 1624 is a predicated MOV (move) instruction predicated on its predicate being “TRUE”. (As in FIG. 13, the predicate for performing the instruction is shown by the logic value after the underscore following the instruction—namely, “_t” for “TRUE”; thus, instruction 1624 only executes once the predicate value becomes available and when the predicate value is “TRUE”.) If the predicate condition is satisfied, the instruction 1624 sends (copies or moves) the value from its right operand to instruction slot 9 as the left operand for that instruction. The predicated move instruction of instruction 1624 thus completes the “TRUE” path by sending (copying) the value computed by instruction I[1] to its intended destination as the new value of y. The predicated move instruction 1624 also writes the new value of y to register R3, thus updating the value of y in register R3. In this way, instruction 1624 serves as a “guarded move” to prevent the earlier computed result from instruction 1621 (instruction I[1]) from being used at instruction 1624 and to prevent R3 from being updated until the “TRUE” condition is established. Instruction 1625 is an instruction that accounts for the situation when the condition is “FALSE”, in which case the value for variable y should still be sent to instruction slot 9 as the left operand, but without any division by 4. In particular, instruction 1625 is a predicated read instruction that specifies that the value of register R3 (original variable y) should be retrieved and sent to instruction slot 9 if the predicate is “FALSE”.

Turning to the second conditional path (path 1514), instruction 1626 is a predicated read instruction predicated on its predicate being “FALSE”. Thus, instruction 1626 only executes once the predicate value becomes available and when the predicate value is “FALSE”. If the predicate condition is satisfied, the instruction 1626 reads the value of register R5, which here corresponds to variable z, and sends it to instruction slot 7 as the right operand for that instruction. With its operand now available for execution, instruction 1627 will perform a decrementing operation SUBI by a specified value, here “1” as specified by “#1”. Further, the result of the decrementing operation is sent to instruction slot 9 as the right operand. The instruction 1627 also writes the new value of z to register R5, thus updating the value of z in register R5. Instruction 1628 is an instruction that accounts for the situation when the condition is TRUE, in which case the value for variable z should still be sent to instruction slot 9 as the right operand, but without decrementing by 1. In particular, instruction 1628 is a predicated read instruction that specifies that the value of register R5 (variable z) should be retrieved sent to instruction slot 9 if the predicate is “FALSE”, but without any decrementing.

Finally, instruction 1629 performs the addition of variables y and z and assignment of the result to variable n after completion of the computations performed along the conditional paths. In particular, once its left and right operands are available, instruction 1629 performs an add operation of those two operands. Instruction 1629 further includes as its target a write operation to a register (R1) in the register file, where R1 corresponds to the register for variable n, instead of another instruction.

As with FIG. 13, in some embodiments of the disclosed block-based processor architecture, a write mask and a store mask are included in the instruction block and include an indication of the registers that will be written to and memory store instructions that will execute during execution of the instruction block. Further, in certain implementations, the control unit for a processor block does not commit an instruction block until all writes and stores in the write and store masks have occurred. To account for this situation, NULL write and NULL store instructions can be used to balance the number of writes and stores along each conditional path. In the example shown in FIG. 16, two null operations could be added to the instruction block to balance the write operations in each path: “I[10] null_t W[R5]” (to place a write operation to R5 in the TRUE path) and “I[11] null_f W[R3]” (to place a write operation to R3 in the FALSE path). Further, the targets for I[3] (which computes the condition) would be modified to include the predicates for new instructions I[10] and I[11].

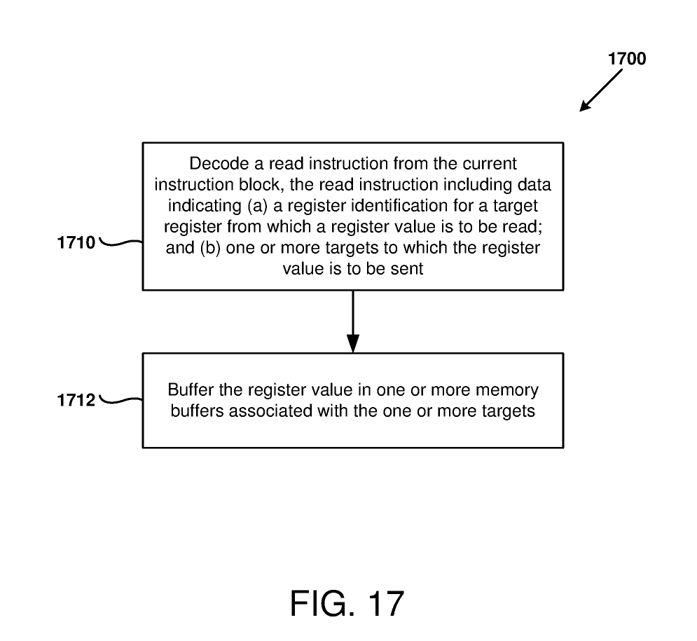

FIGS. 17-19 are flow charts showing generalized embodiments for generating and using read instructions and predicated read instructions in accordance with the disclosed technology.

FIG. 17 is a flow chart 1700 showing an example method for operating a processor in accordance with the disclosed technology. The illustrated method can be performed, for example, by a control unit of a block-based processor core in a block-based processor. More specifically, the block-based processor core can comprise one or more functional units configured to perform functions on one or more operands; and a control unit configured to execute instructions in a current instruction block and control operation of the one or more functional units.

At 1710, the control unit decodes a read instruction from the current instructions block. In this example, and as discussed above, the read instruction includes data indicating (a) a register identification for a target register from which a register value is to be read; and (b) one or more targets to which the register value is to be sent.

At 1712, the control unit buffers the register value in one or more memory buffers associated with the one or more targets (e.g., left operand buffer 242, right operand buffer 243, and/or predicate buffer 244).

The example method illustrated in FIG. 17 can be applied in a variety of scenarios. In some cases, the one or more targets include an instruction to perform a function, and the control unit is further configured to: decode the instruction to perform the function; and execute the function using one of the functional units and while using the register value as an operand for the function. In certain cases, the one or more targets include a predicated instruction to perform a function, and the control unit is further configured to decode the predicated instruction for performing the function, evaluate the register value as a predicate to performing the function, and conditionally execute the function using one of the functional units based on the outcome of the evaluation. In some cases, at least one of the targets specifies another instruction in the current instruction block and an indication of an operand type for which the register value is to be used during execution of the other instruction. In certain cases, at least one of the targets is a broadcast channel for the at least one of the cores. In some cases, at least one of the targets specifies another instruction in the current instruction block and an indication that the register value is to be used as a predicate for that other instruction. In certain cases, the read instruction is a predicated read instruction, and the control unit is configured to execute the predicated read instruction only when a predicate for the predicated read instruction is satisfied. In some cases, the predicate for the predicated read instruction is an outcome of another instruction in the instruction block that targets the predicated read instruction.

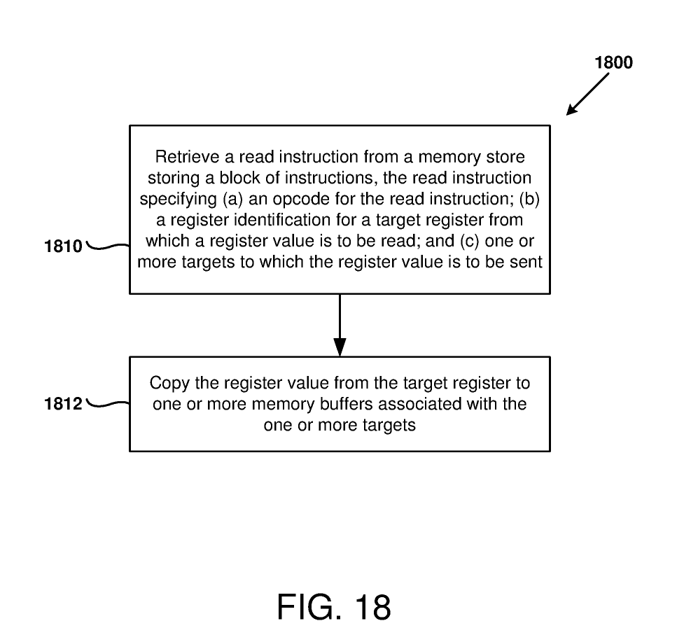

FIG. 18 is another flow chart 1800 showing another example method for operating a processor in accordance with the disclosed technology. In example implementations, the method is performed by a processor core of a block-based processor.

At 1810, a read instruction is retrieved from a memory store of the block-based processor storing a block of instructions, the read instruction specifying (a) an opcode for the read instruction; (b) a register identification for a target register from which a register value is to be read; and (c) one or more targets to which the register value is to be sent.

At 1812, the register value is copied from the target register to one or more memory buffers associated with the one or more targets (e.g., left operand buffer 242, right operand buffer 243, and/or predicate buffer 244).

In particular implementations, no operation is performed by the read instruction using the register value other than the copying. In some implementations, the copying comprises copying the register value from the target register to a memory buffer for an instruction yet to be executed. In particular implementations, the memory buffer is for one of: (a) a predicate for the instruction yet to be executed; (b) an operand for the instruction yet to be executed; and/or (c) a broadcast channel for the processor core. In some instances, the read instruction is an unpredicated read instruction and is performed as part of executing a conditional function before or at least partially during determination of a condition on which the conditional function depends.

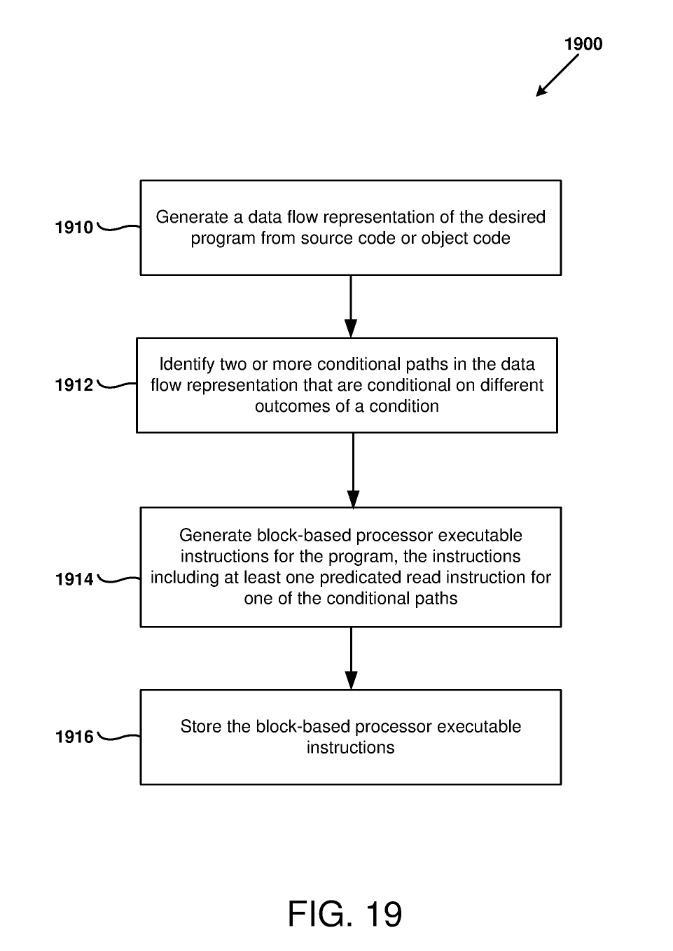

FIG. 19 is a flow chart 1900 showing an example compilation method for generating block-based processor executable instructions from, for example, source code or object code for a program. The compilation method illustrated in FIG. 19 can be performed, for example, using one or more memory or storage devices storing source code or object code for a program; and one or more processing units coupled to the one or more memory or storage devices and configured to generate executable instructions for a block-based processor from the source code or object code. For example, the one or more processing units can themselves be block-based processors, and/or the one or more processing units can be configured to execute the block-based processor executable instructions.

At 1910, a data flow representation of the desired program is generated from the source code or object code.

At 1912, two or more conditional paths in the data flow representation are identified that are conditional on different outcomes of a condition.

At 1914, block-based processor executable instructions for the program are generated. In this example, the block-based processor executable instructions include at least one predicated read instruction for one of the conditional paths.

At 1916, the block-based processor executable instructions are stored.

In particular implementations, the generation of the executable instructions for the block-based processor from the source code or object code is performed by: determining that one of the conditional paths is more likely to occur than other ones of the conditional paths; and generating block-based processor executable instructions for the program in which instructions for the conditional path that is more likely to occur include at least one unpredicated read instruction. In some implementations, the unpredicated read instruction causes the block-based processor to execute the unpredicated read instruction prior to or concurrently with determination of the condition. In particular implementations, the read instruction specifies (a) a register identification for a target register from which a register value is to be read; and (b) one or more targets to which the register value is to be sent. In some implementations, the generation of the executable instructions for the block-based processor from the source code or object code is performed by balancing a number of register writes, memory writes, or both register writes and memory writes in the one or more conditional paths.

### XIII. Exemplary Computing Environment

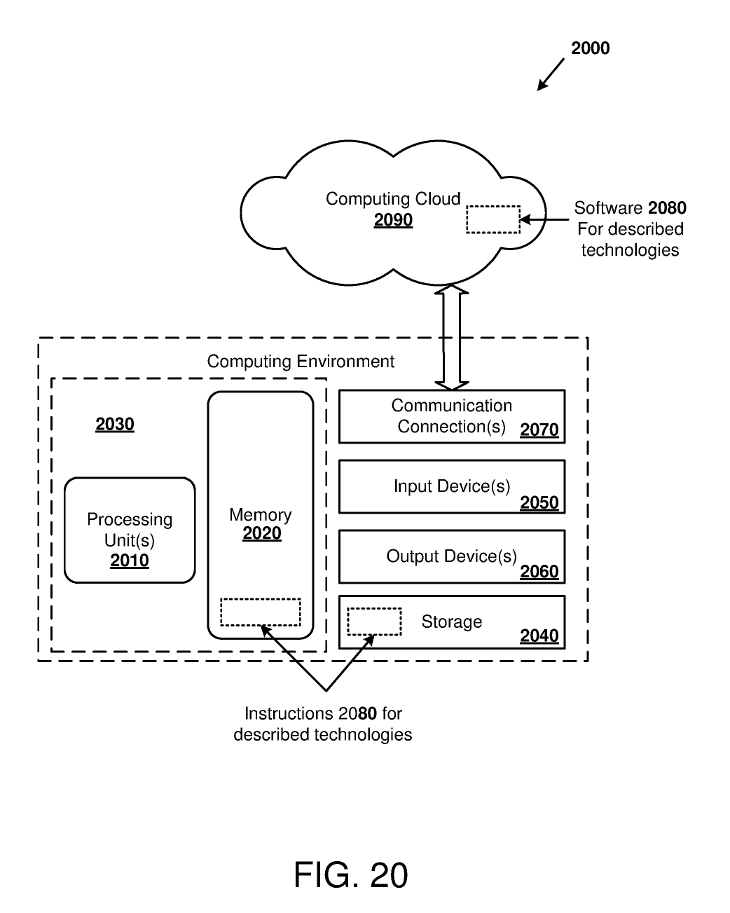

FIG. 20 illustrates a generalized example of a suitable computing environment 2000 in which described embodiments, techniques, and technologies, including configuring a block-based processor, can be implemented. For example, the computing environment 2000 can implement disclosed techniques for configuring a processor to operating according to one or more instruction blocks, or compile code into computer-executable instructions for performing such operations, as described herein.

The computing environment 2000 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 20, the computing environment 2000 includes at least one block-based processing unit 2010 and memory 2020. In FIG. 20, this most basic configuration 2030 is included within a dashed line. The block-based processing unit 2010 executes computer-executable instructions and may be a real or a virtual processor. In a multi-processing system, multiple processing units execute computer-executable instructions to increase processing power and as such, multiple processors can be running simultaneously. The memory 2020 may be volatile memory (e.g., registers, cache, RAM), non-volatile memory (e.g., ROM, EEPROM, flash memory, NVRAM, etc.), or some combination of the two. The memory 2020 stores software 2080, images, and video that can, for example, implement the technologies described herein. A computing environment may have additional features. For example, the computing environment 2000 includes storage 2040, one or more input device(s) 2050, one or more output device(s) 2060, and one or more communication connection(s) 2070. An interconnection mechanism (not shown) such as a bus, a controller, or a network, interconnects the components of the computing environment 2000. Typically, operating system software (not shown) provides an operating environment for other software executing in the computing environment 2000, and coordinates activities of the components of the computing environment 2000.

The storage 2040 may be removable or non-removable, and includes magnetic disks, magnetic tapes or cassettes, CD-ROMs, CD-RWs, DVDs, or any other medium which can be used to store information and that can be accessed within the computing environment 2000. The storage 2040 stores instructions for the software 2080, plugin data, and messages, which can be used to implement technologies described herein.

The input device(s) 2050 may be a touch input device, such as a keyboard, keypad, mouse, touch screen display, pen, or trackball, a voice input device, a scanning device, or another device, that provides input to the computing environment 2000. For audio, the input device(s) 2050 may be a sound card or similar device that accepts audio input in analog or digital form, or a CD-ROM reader that provides audio samples to the computing environment 2000. The output device(s) 2060 may be a display, printer, speaker, CD-writer, or another device that provides output from the computing environment 2000.

The communication connection(s) 2070 enable communication over a communication medium (e.g., a connecting network) to another computing entity. The communication medium conveys information such as computer-executable instructions, compressed graphics information, video, or other data in a modulated data signal. The communication connection(s) 2070 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

Some embodiments of the disclosed methods can be performed using computer-executable instructions implementing all or a portion of the disclosed technology in a computing cloud 2090. For example, disclosed compilers and/or block-based-processor servers are located in the computing environment, or the disclosed compilers can be executed on servers located in the computing cloud 2090. In some examples, the disclosed compilers execute on traditional central processing units (e.g., RISC or CISC processors).

Computer-readable media are any available media that can be accessed within a computing environment 2000. By way of example, and not limitation, with the computing environment 2000, computer-readable media include memory 2020 and/or storage 2040. As should be readily understood, the term computer-readable storage media includes the media for data storage such as memory 2020 and storage 2040, and not transmission media such as modulated or propagating data signals per se.

### XIV. Concluding Remarks

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An apparatus, comprising one or more block-based processor cores, at least one of the processor cores comprising:
one or more functional units configured to perform functions for one or more operands; and
a control unit configured to execute instructions in a current instruction block and control operation of the one or more functional units, the control unit being further configured to:
decode a read instruction from the current instructions block, the read instruction including data indicating (a) a register identification for a source register from which a register value is to be read; and (b) one or more targets to which the register value is to be sent; and
buffer the register value in one or more memory buffers associated with the one or more targets.

2. The apparatus of claim 1, wherein the one or more targets comprise an instruction to performing a function, and wherein the control unit is further configured to:
decode the instruction to perform the function; and
execute the function using one or more of the functional units while using the register value as an operand for the function.

3. The apparatus of claim 1, wherein the one or more targets include a predicated instruction to perform a function, and wherein the control unit is further configured to:
decode the predicated instruction to perform the function;
evaluate the register value as a predicate to performing the function; and
conditionally execute the function using one of the functional units based on the outcome of the evaluation.

4. The apparatus of claim 1, wherein at least one of the targets specifies another instruction in the current instruction block and an indication of an operand type for which the register value is to be used during execution of the another instruction.

5. The apparatus of claim 1, wherein at least one of the targets is a broadcast channel for the at least one of the processor cores.

6. The apparatus of claim 1, wherein at least one of the targets specifies another instruction in the current instruction block and an indication that the register value is to be used as a predicate for the another instruction.

7. The apparatus of claim 1, wherein the read instruction is a predicated read instruction, and wherein the control unit is configured to execute the predicated read instruction only when a predicate for the predicated read instruction is satisfied.

8. The apparatus of claim 7, wherein the predicate for the predicated read instruction is an outcome of another instruction in the instruction block that targets the predicated read instruction.

9. A compilation system for a block-based processor, comprising:
one or more memory or storage devices storing source code and/or object code for a program; and
one or more processing units coupled to the one or more memory or storage devices and configured to generate executable instructions for a block-based processor from the source code or object code by:
generating a control flow representation of the desired program from the source code and/or object code;
identifying two or more conditional paths in the data flow representation that are conditional based on different outcomes of a condition;
generating block-based processor executable instructions for the program, the block-based processor executable instructions including at least one predicated read instruction for one of the conditional paths; and
storing the block-based processor executable instructions.

10. The compilation system of claim 9, wherein the one or more processing units are further configured to generate the executable instructions for the block-based processor from the source code and/or object code by:
determining that one of the conditional paths is more likely to occur than other ones of the conditional paths; and
generating block-based processor executable instructions for the program in which instructions for the one of the conditional paths that is more likely to occur include at least one unpredicated read instruction.

11. The compilation system of claim 10, wherein the at least one unpredicated read instruction causes the block-based processor to execute the unpredicated read instruction prior to or concurrently with the determination of the condition.

12. The compilation system of claim 9, wherein the read instruction specifies (a) a register identification for a target register from which a register value is to be read; and (b) one or more targets to which the register value is to be sent.

13. The compilation system of claim 9, wherein the one or more processing units are block-based processors, and wherein the one or more processing units are further configured to execute the block-based processor executable instructions.

14. The compilation system of claim 9, wherein the one or more processing units are further configured to generate the executable instructions for the block-based processor from the source code and/or object code by balancing a number of register writes, memory writes, or both register writes and memory writes in the one or more conditional paths.

15. A method, comprising:
in a processor core of a block-based processor,
retrieving a read instruction from a memory store storing a block of instructions, the read instruction specifying (a) an opcode for the read instruction; (b) a register identification for a target register from which a register value is to be read; and (c) one or more targets to which the register value is to be sent; and
copying the register value from the target register to one or more memory buffers associated with the one or more targets.

16. The method of claim 15, wherein no operation is performed by the read instruction using the register value other than the copying.

17. The method of claim 15, wherein the copying comprises copying the register value from the target register to a memory buffer for an instruction yet to be executed.

18. The method of claim 17, wherein the memory buffer is for one of: (a) a predicate for the instruction yet to be executed; or (b) an operand for the instruction yet to be executed.

19. The method of claim 17, wherein the memory buffer is for a broadcast channel for the processor core.

20. The method of claim 15, wherein the read instruction is an unpredicated read instruction and is performed as part of executing a conditional operation before or concurrently with determination of a condition on which the conditional operation depends.
